(19) United States
(12) Patent Application Publication
(10) Pub. No.: US 2020/0167843 A1
(43) Pub. Date: May 28, 2020

(54) SYSTEMS AND METHODS FOR REMOTE AGE-BASED AUTHORIZATION

(71) Applicant: SKUPOS Inc., San Francisco, CA (US)

(72) Inventors: Nam Nguyen, San Francisco, CA (US); Richard Woolsey, Foster City, CA (US); Po Chen Lin, Burlingame, CA (US); Jacob Bolling, Sausalito, CA (US); Zachary Kimball, San Francisco, CA (US); Michael Glassman, San Francisco, CA (US)

(73) Assignee: SKUPOS Inc., San Francisco, CA (US)

(21) Appl. No.: 16/247,524

(22) Filed: Jan. 14, 2019

Related U.S. Application Data
(63) Continuation-in-part of application No. 16/200,568, filed on Nov. 26, 2018.

(51) Int. Cl. G06Q 30/06; G06Q 20/20

(52) U.S. Cl. CPC G06Q 30/0607; G06K 7/1413; G06Q 20/208; G06Q 20/202

(57) ABSTRACT

Obtain first item data from a first client system coupled to a central server system via a WAN in response to the first item data being obtained by the first client system from a first point of sale system via a first LAN in response to the first item data being obtained by the first point of sale system at a first time. Determine whether the first item data is age-restricted. Provide, in response to determining the first item data is age-restricted, an age-restriction notification to the first client system via the WAN, the age-restriction notification being capable of preventing the first point of sale system from completing a transaction including the first item data unless a subsequent message indicating the transaction is eligible for completion.

### CROSS-REFERENCE TO RELATED APPLICATIONS

The present application is a continuation-in-part of U.S. patent application Ser. No. 16/200,568, filed Nov. 26, 2018, and entitled “Systems and Methods for Communicating and Enhancing Local Data for Remote Processing,” which is hereby incorporated by reference herein.

### TECHNICAL FIELD

This disclosure pertains to systems for communicating and applying modification objects. More specifically, this disclose pertains to systems for communicating and applying retailer-agnostic modification objects.

### BACKGROUND

Under conventional approaches, a computing system may be limited to local-area networks (LANs) and may be unable to connect to wide-area networks (WANs). For example, a point of sale system in a retail store may only include functionality for communicating over a cable LAN connection to another computing system in the retail store, and may not include functionality for connecting to the Internet or other WANs. Accordingly, such a point of sale system cannot communicate local data generated by the point of sale system to a cloud server, for example, and nor is the local data generated by such a point of sale system intended to be communicated over the Internet and/or processed by a remote system.

### SUMMARY

Various embodiments of the present disclosure include systems, methods, and non-transitory computer readable media configured to obtain first item data from a first client system coupled to a central server system via a wide-area network (WAN) in response to the first item data being obtained by the first client system from a first point of sale system via a first local-area network (LAN) in response to the first item data being obtained by the first point of sale system at a first time, the first point of sale system being associated with a first owner entity. Determine whether the first item data is age-restricted. Provide, in response to determining the first item data is age-restricted, an age-restriction notification to the first client system via the WAN, the first client system being configured to provide the age-restriction notification to the first point of sale system via the first LAN, the age-restriction notification being capable of preventing the first point of sale system from completing a transaction including the first item data without obtaining a subsequent message indicating the transaction is eligible for completion.

In some embodiments, the first item data comprises a universal product code (UPC).

In some embodiments, the systems, methods, and non-transitory computer readable media configured to perform obtaining, in response to determining the first item data is age-restricted, a secure user identifier from the first client system via the WAN in response to the user identifier being obtained by the first client system from the first point of sale system via the first LAN in response to the user identifier being obtained by the first point of sale system at a second time; providing, in response to obtaining the secure user identifier, the secure user identifier to a remote third-party system over the WAN, the remote third-party system capable of determining an authenticity of the secure user identifier; receiving, over the WAN, a status message from the remote third-party system, the status message indicating whether secure user identifier is authentic or not authentic.

In some embodiments, the secure user identifier comprises at least a portion of identification information of a driver's license. For example, the identification information may include a driver's license number, a barcode, a picture, and/or the like.

In some embodiments, the remote third-party system comprises a Department of Motor Vehicles (DMV) system.

In some embodiments, the systems, methods, and non-transitory computer readable media configured to perform if the status message indicates that the secure user identifier is not authentic, providing an invalid secure user identifier notification to the first client system via the WAN, the first client system being configured to provide the invalid secure user identifier notification to the first point of sale system via the first LAN, the invalid secure user identifier notification being capable of preventing the first point of sale system from completing the transaction including the first item data without obtaining the subsequent message indicating the transaction is eligible for completion.

In some embodiments, the systems, methods, and non-transitory computer readable media configured to perform if the status message indicates that the secure user identifier is authentic, providing a valid secure user identifier notification to the first client system via the WAN, the first client system being configured to provide the valid secure user identifier notification to the first point of sale system via the first LAN, the valid secure user identifier notification being capable of causing the first point of sale system to be allowed to complete the transaction including the first item data.

Various embodiments of the present disclosure include systems, methods, and non-transitory computer readable media configured to obtain first item data from a first client system coupled to a central server system via a wide-area network (WAN) in response to the first item data being obtained by the first client system from a first point of sale system via a first local-area network (LAN) in response to the first item data being obtained by the first point of sale system at a first time, the first point of sale system being associated with a first owner entity. Identify a first modification object associated with the first item data. Provide, in response to the identification of the first modification object, the first modification object to the first client system via the WAN, the first client system being configured to provide the first modification object to the first point of sale system via the first LAN. Obtain a user identifier from the first client system via the WAN in response to the user identifier being obtained by the first client system from the first point of sale system via the first LAN in response to the user identifier being obtained by the first point of sale system at a second time. Identify a first user associated with the user identifier as being eligible to receive the first modification object. Provide, in response to the identification of the first user as being eligible to receive the first modification object, an eligibility message to the first client system over the WAN, the first eligibility message indicating eligibility of the first user to receive the first modification object, the first client system being configured to provide the first eligibility message to the first point of sale system, the first point of sale being configured to generate first modified transaction data based on the first modification object immediately after the later of the first time and the second time. Obtain second item data from a second client system coupled to the central server system via the WAN in response to the second item data being obtained by the second client system from a second point of sale system via a second LAN in response to the second item data being obtained by the second point of sale system at a third time, the second point of sale system being associated with a second owner entity. Identify a second modification object associated with the second item data. Provide, in response to the identification of the second modification object, the second modification object to the second client system via the WAN, the second client system being configured to provide the second modification object to the second point of sale system via the second LAN. Obtain the user identifier from the second client system via the WAN in response to the user identifier being obtained by the second client system from the second point of sale system via the second LAN in response to the user identifier being obtained by the second point of sale system at a fourth time. Identify a second user associated with the user identifier as being eligible to receive the second modification object. Provide, in response to the identification of the user as being eligible to receive the second modification object, a second eligibility message to the second client system over the WAN, the second eligibility message indicating eligibility of the user to receive the second modification object, the second client system being configured to provide the second eligibility message to the second point of sale system, the second point of sale being configured to generate second modified transaction data based on the second modification object immediately after the later of the third time and the fourth time.

In some embodiments, the first modification object is associated with a first brand system. In some embodiments, the identifying the first modification object further comprises identifying the first modification object from a first set of modification objects managed by the central server system.

In some embodiments, the second modification object is associated with a second brand system. In some embodiments, the identifying the second modification object further comprises obtaining the second modification object from a second set of modification objects managed by the second brand system. In some embodiments, the central server system obtains the second modification object using one or more first application programming interfaces (APIs) of the central server system, the one or more first APIs being configured to cooperate with one or more second APIs of the second brand system.

In some embodiments, the identifying the first modification object further comprises identifying the first modification object based on the user identifier and the first item data. In some embodiments, the identifying the second modification object further comprises identifying the second modification object based on the user identifier and the second item data.

A claimed solution rooted in computer technology overcomes problems specifically arising in the realm of computer technology. In various embodiments, a computing system is configured to provide a central server system configured to enhance local data obtained from client systems. In some embodiments, the client systems may obtain local data from point of sale systems over respective local-area network (LAN) connections, and then provide the local data to the central server system over a wide-area network (WAN) connection. For example, a first point of sale system (e.g., a Verifone point of sale system) and a corresponding first client system may be located in a first retail store (e.g., “Joe's Store”) owned by a first entity (e.g., “Joe Smith”). The first point of sale system and the first client system may be connected to each other via a LAN connection (e.g., a cable connection). A second point of sale system (e.g., a Gilbarco point of sale system) and a corresponding second client system may be located in a second retail store (e.g., “John's Store”) owned by a second entity (e.g., “John Doe”). The second point of sale system and the second client system may be connected to each other via another LAN connection (e.g., another cable connection). Each of the client systems may provide the local data obtained from their respective point of sale system to the central server system (e.g., via periodic data pushes and/or in response to pull requests). The central server system may also filter and/or format the local data. For example, the central server system may filter the local data to remove duplicate data entries. The central server system may format the local data to correspond to a format required by a target system (e.g., a brand system or a distributor system), and then provide the target-formatted data to the target system.

The computing system may allow, for example, local data obtained from a variety of different retail stores owned by a variety of different owners and using a variety of different point of sale systems to be provided to remote systems as if the different retail stores were a single entity. Furthermore, such local data typically would never reach and/or be processed by remote systems (e.g., brand systems and/or distributor systems), and even if the local data did reach those remote systems, it would not be in the appropriate format for receipt and/or processing by those remote systems. Accordingly, the computing system provides a central system that obtains, stores, and provides local data obtained from disparate, and often distant, point of sale systems in an enhanced format capable of being efficiently received and/or processed by one or more remote systems.

Various embodiments of the present disclosure include systems, methods, and non-transitory computer readable media configured to obtain first local data from a first client system connected to the central server system via a wide-area network (WAN), the first local data generated by a first point of sale system connected to the first client system via a first local-area network (LAN), the first point of sale system being associated with a first owner entity, the first local data being obtained from the first point of sale system by the first client system via the first LAN, and the first local data being generated by the first point of sale system according to a first data format. Second local data is obtained from a second client system connected to the central server system via the WAN, the second local data generated by a second point of sale system connected to the second client system via a second LAN, the second point of sale system being associated with a second owner entity, the second local data being obtained from the second point of sale system by the second client system via the second LAN, and the second local data being generated by the second point of sale system according to a second data format. The first local data and the second local data are filtered based on one or more filtering rules associated with the first point of sale system and the second point of sale system. A first remote target system is identified. At least a portion of the filtered data is selected, the at least a portion of the filtered data including filtered data associated with the first owner entity and filtered data associated with the second owner entity. Target-formatted data is generated from the selected filtered data based on a first interface associated with the first remote target system, the target-formatted data having a third data format associated with the first remote target system, the target-formatted data appearing to be associated with a single owner entity. The target-formatted data is provided to the first remote target system.

In some embodiments, the first client system obtains the first local data using one or more application programming interfaces (APIs) associated with the first point of sale system.

In some embodiments, the second client system obtains the second local data using a file system associated with the point of sale system.

In some embodiments, the first point of sale system and the second point of sale system are not capable of WAN connections.

In some embodiments, the filtering includes removing duplicate data entries from the first local data caused by a periodic pull used by the first client system to obtain the first local data from the point of sale system.

In some embodiments, the second client system obtains the second local data in response to detecting a create event associated with the file system.

In some embodiments, the systems, methods, and non-transitory computer readable media further configured to obtain third local data from the first client system connected to the central server system via the WAN, the third local data generated by a third point of sale system connected to the first client system via the first LAN, the third point of sale system being associated with the first owner entity, the third local data being obtained from the third point of sale system by the third client system via the first LAN, and the third local data being generated by the first point of sale system according to the first data format; filtering the third local data; generating a first report associated with the first and third filtered local data; and providing the first report to an owner system.

In some embodiments, the systems, methods, and non-transitory computer readable media further configured to obtain fourth local data from a third client system connected to the central server system via the WAN, the fourth local data generated by a fourth point of sale system connected to the third client system via a third LAN, the fourth point of sale system being associated with the first owner entity, the fourth local data being obtained from the fourth point of sale system by the fourth client system via the third LAN, and the fourth local data being generated by the fourth point of sale system according to the second data format; filtering the fourth local data; generating, in response to a query received from the owner system, a second report associated with the first filtered local data, the third filtered local data, and the fourth filtered local data; and providing the second report to the owner system.

In some embodiments, the systems, methods, and non-transitory computer readable media further configured to identify a second remote target system; select at least a second portion of the filtered data, the at least a portion of the filtered data including filtered data associated with the first point of sale system, the second point of sale system, the third point of sale system, and the fourth point of sale system; generate second target-formatted data from the second portion of the filtered data based on a second interface associated with the second remote target system, the second target-formatted data having a fourth data format associated with the second remote target system, the second target-formatted data appearing to be associated with the single owner entity; and provide the second target-formatted data to the second remote target system

In some embodiments, the first LAN comprises a first direct cable connection between the first point of sale system and the first client system, and the second LAN comprises a second direct cable connection between the second point of sale system and the second client system.

In some embodiments, the first local data is obtained in response to a periodic pull request during a persistent authenticated session between the first client system and the first point of sale system.

In some embodiments, the first remote target system is identified in response to a request for a report associated with the first remote target system. In some embodiments, the request identifies one or more variables, and the at least a portion of the filtered data is selected based on the one or more variables.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example network system for communicating and enhancing local data for remote processing, according to some embodiments.

FIG. 2 depicts a diagram of an example of a client system, according to some embodiments.

FIG. 3 depicts a diagram of an example of a central server system, according to some embodiments.

FIG. 4 depicts a diagram of an example of an owner system, according to some embodiments.

FIG. 5 depicts a flowchart of an example method of operation of a central server system, according to some embodiments.

FIG. 6 depicts a flowchart of an example method of operation of a client system connected to an API-based point of sale system, according to some embodiments.

FIG. 7 depicts a flowchart of an example method of operation of a client system connected to a file system-based point of sale system, according to some embodiments.

FIG. 8 depicts a flowchart of an example method of an owner system, according to some embodiments.

FIG. 9 depicts a diagram of an example of a brand system, according to some embodiments.

FIG. 10 depicts a flowchart of an example method of operation of a central server system for providing retailer agnostic rewards, according to some embodiments.

FIG. 11 depicts a flowchart of an example method for providing retailer agnostic rewards managed by a central server system, according to some embodiments.

FIG. 12 depicts a flowchart of an example method for providing retailer agnostic rewards managed by a brand system, according to some embodiments.

FIG. 13 depicts a flowchart of an example method of operation of a central server system for providing age verification of age-restricted items.

FIG. 14 is a diagram of an example computer system for implementing the features disclosed herein, according to some embodiments.

### DETAILED DESCRIPTION

Under conventional approaches, rewards may be offered by various retailers (e.g., Safeway, Walgreens). The rewards are typically specific to a particular retailer. For example, a user may be required to use a Safeway identifier (e.g., a Safeway card) to receive rewards at a Safeway, and may be required to use a different Walgreens identifier (e.g., a Walgreens card) to receive rewards at a Walgreens. This may, for example, require a de-centralized system that is inefficient (e.g., high network latency) and/or computationally expensive.

In some embodiments, a claimed solution rooted in computer technology overcomes problems specifically arising in the realm of computer technology. In various embodiments, a computing system is configured to provide and/or facilitate retailer-agnostic rewards based on retailer-agnostic user identifiers. For example, a user may be able to use a single user identifier (e.g., the user's phone number) to obtain rewards from different retailers (e.g., Joe's Store and John's Store). Rewards may be obtained in real-time and/or be brand-specific. For example, a user may be able to obtain both a Pepsi reward and a Coca-Cola reward in response to providing the user identifier at John's Store, and obtain the Coca-Cola reward in response to providing the same user identifier at Joe's Store. The computing system may, for example, provide a central location for providing and/or facilitating rewards that is more efficient and/or less computationally expensive than conventional approaches. The computing system may, for example, reduce network latency relative to traditional de-centralized systems.

In some embodiments, the computing system is configured to provide and/or facilitate age verification. For example, a user may attempt to purchase an age-restricted product (e.g., tobacco, alcohol). The computing system may determine whether the user is eligible to purchase the age restricted product (e.g., over 18 years old, over 21 years old). For example, the computing system may obtain a secure user identifier (e.g., a driver's license) for the user, and then access a verified information datastore system (e.g., a Department of Motor Vehicles database system) to determine whether the secure user identifier is authentic. If the secure user identifier indicates an eligible age (e.g., over 18 years old, over 21 years old), and if the secure user identifier is determined to be authenticate, the computing system may authorize the purchase. Otherwise, the computing system may deny the purchase. For example, a corresponding point of sale system may be unable to complete the purchase. Accordingly, a clerk at a retailer may be prevented at the point of sale system from selling age-restricted products to a minor, even if the clerk tried to complete the purchase.

In some embodiments, a claimed solution rooted in computer technology overcomes problems specifically arising in the realm of computer technology. In various embodiments, a computing system is configured to provide local data to a central server system configured to enhance the local data obtained from client systems. In some embodiments, the client systems may obtain local data from point of sale systems over respective local-area network (LAN) connections, and then provide the local data to the central server system over a wide-area network (WAN) connection. For example, a first point of sale system (e.g., a Verifone point of sale system) and a corresponding first client system may be located in a first retail store (e.g., “Joe's Store”) owned by a first entity (e.g., “Joe Smith”). The first point of sale system and the first client system may be connected to each other via a LAN connection (e.g., a cable connection). A second point of sale system (e.g., a Gilbarco point of sale system) and a corresponding second client system may be located in a second retail store (e.g., “John's Store”) owned by a second entity (e.g., “John Doe”). The second point of sale system and the second client system may be connected to each other via another LAN connection (e.g., another cable connection). Each of the client systems may provide the local data obtained from their respective point of sale systems to the central server system (e.g., via periodic data pushes and/or in response to pull requests). The central server system may filter and/or format the local data. For example, the central server system may filter the local data to remove duplicate data entries. The central server system may format the local data (e.g., a subset of the local data that is relevant to the target system or to the user of the target system) to correspond to a format required by a target system (e.g., a brand system or a distributor system), and then provide the target-formatted data to the target system.

The computing system may allow, for example, local data obtained from a variety of different retail stores owned by a variety of different owners and using a variety of different point of sale systems to be provided to remote systems as if the different retail stores were a single entity. Further, such local data typically would never reach and/or be processed by remote systems (e.g., brand systems and/or distributor systems), and even if the local data did reach those remote systems, it would not be in the appropriate format for receipt and/or processing by those remote systems. Accordingly, the computing system provides a central system that obtains, stores, and provides local data obtained from disparate, and often distant, point of sale systems in an enhanced format capable of being efficiently received and/or processed by one or more remote systems.

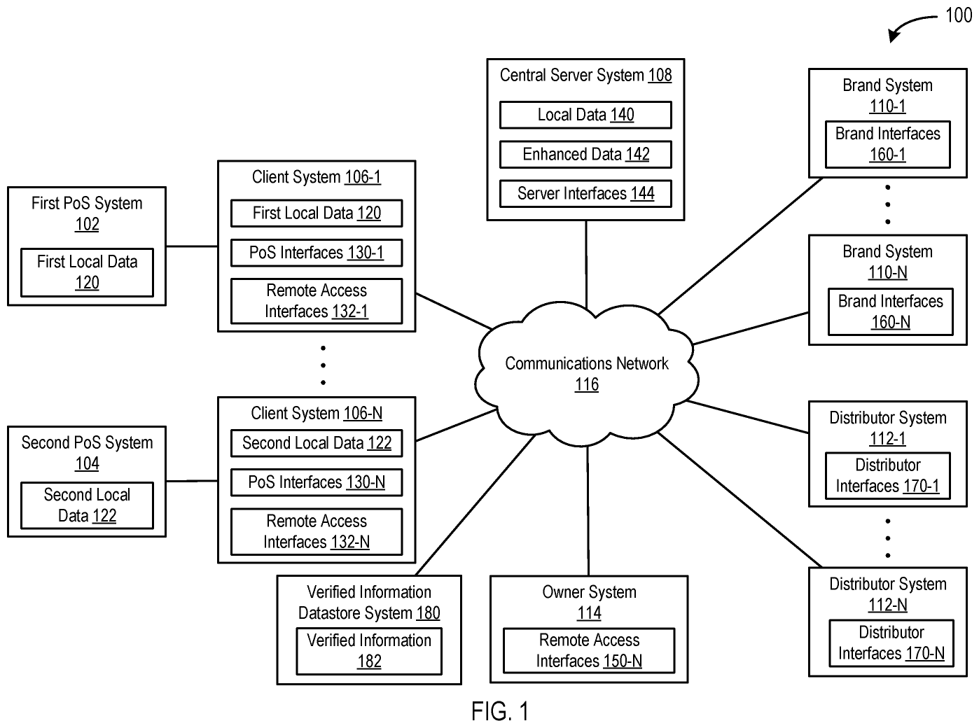

FIG. 1 depicts a diagram of an example network system 100 for communicating and enhancing local data for remote processing according to some embodiments. In the example of FIG. 1, the network system 100 includes a first point of sale system 102, a second point of sale system 104, client systems 106-1 to 106-N (individually, the client system 106, collectively, the client systems 106), a central server system 108, brand systems 110-1 to 110-N (individually, the brand system 110, collectively, the brand systems 110), distributor systems 112-1 to 112-N (individually, the distributor system 112, collectively, the distributor systems 112), an owner system 114, and a communication network 116. While FIG. 1 depicts a single first point of sale system 102, a single second point of sale system 104, and a single owner system 114, this is for illustrative purposes and various embodiments may include any number of such systems.

The first point of sale system 102 may function to generate and/or transmit first local data 120. In various embodiments, functionality of the first point of sale system 102 may be performed by one or more computing devices implementing the first point of sale system 102 (e.g., a Verifone point of sale system). For example, the first point of sale system 102 may be located in a retail store (e.g., a convenience store). In some embodiments, the first point of sale system 102 may be accessed using one or more application programming interfaces (APIs) associated with the first point of sale system 102. For example, Verifone APIs may be used to access the first point of sale system 102 from a computing device connected thereto over a local-area connection (e.g., direct cable connection, local Wi-Fi connection). As used herein, “local data” may be data generated by a system that is not capable of connecting to a wide-area network (WAN). For example, local data may be transaction logs generated by a point of sale system (e.g., point of sale system 102) that is limited to providing transaction logs over local-area connections, and is not capable of accessing the Internet and/or other wide-area network. Local data may include item data. Item data may include a UPC code and/or other identifier of an item (e.g., a bottle of Pepsi).

In some embodiments, local data may be associated with one or more data formats (or, simply, “formats”) and include content (e.g., text data, image data, audio data). For illustrative clarify, “local data” may refer to first local data 120, second local data 122 (discussed below), local data 140 (discussed below), and/or other local data. Formats may include tabular formats (e.g., tables with columns and rows), object-oriented formats, and/or the like. Formats also may include markup language formats (e.g., XML). Local data may also be associated with a point of sale system. For example, first local data 120 may have a format specific to a type of point of sale system (e.g., Verifone format), and second local data 122 may have a format specific to another type of point of sale system (e.g., Gilbarco point of sale system). Accordingly, local data may include Verifone transaction logs, Gilbarco transaction logs, and/or other types of transaction logs.

The second point of sale system 104 may function to generate and/or transmit second local data 122. In various embodiments, functionality of the second point of sale system 104 may be performed by one or more computing devices implementing the second point of sale system 104 (e.g., Gilbarco point of sale system). In some embodiments, the second point of sale system 104 may generate and/or store second local data 122 in a file system, such as an operating system file system (e.g., a Windows file system). Accordingly, the second point of sale system 104 may be accessed (e.g., to obtain second local data 122) using file system protocols, and may not require specific point of sale system APIs to be accessed.

The client systems 106 may function to obtain first local data 120 and/or second local data 122. In various embodiments, functionality of the client systems 106 may be performed by one or more computing devices (e.g., desktop computers, mobile devices, servers). For example, the client systems 106 may comprise Windows-based computers located in retail stores. In some embodiments, client systems 106 may be connected to one or more first point of sale system 102 and/or one or more second point of sale system 104. For example, client systems 106 may be located in the same retail store as one or more first point of sale systems 102 and/or one or more second point of sale systems 104, and connected thereto by one or more local connections (e.g., a direct cable connection, a local-hub connection, local Wi-Fi connection, and/or the like).

In some embodiments, the client systems 106 may use one or more point of sale system interfaces 130 to access first point of sale systems 102 and/or second point of sale systems 104 (e.g., in order to obtain first local data 120 and/or second local data 122). For example, a first set of a point of sale system interfaces 130 may include API-based point of sale system interfaces (e.g., for accessing first point of sale systems 102) and a second set of point of sale system interfaces 130 may include file system-based point of sale interfaces (e.g., for accessing second point of sale systems 104). The API-based point of sale interfaces 130 may allow the client systems 106 to hook directly into a first point of sale system 102, while the file system-based point of sale interfaces 130 utilize operating system file system APIs and/or protocols to access a file system of the point of sale system 104.

In some embodiments, the client systems 106 function to receive and/or establish secure remote access connections with one or more remote systems over a communication network. For example, the client systems 106 may function to receive and/or establish virtual private network (VPN) connections (or, “tunnels”) with one or more remote systems over communication network 116. The secure remote access connections may, for example, allow a remote user to interact with the client systems 106 as if the remote user were on site at the physical location of the clients system 106 (e.g., the retail store including the client system 106). Additionally, the secure remote access connections may allow a remote user to access different client system 106 without having to physically travel to each of the retail stores including those client system 106.

The central server system 108 may function to obtain local data 140. Local data 140 may include first local data 120 and/or second local data 122. In various embodiments, functionality of the central server system 108 may be performed by one or more servers (e.g., a cloud-based server) and/or other computing devices. The central server system 108 may obtain local data 140 over a communications network (e.g., communications network 116). In some embodiments, the central server system 108 may use one or more central server system interfaces 144 to communicate with client systems 106 to obtain local data 140. The central server system interfaces 144 may include application programming interfaces (APIs), software development kits (SDKs), source code, machine code, and/or server stubs. Accordingly, the central server system interfaces 144 may include files (e.g., source code files), documents, executables, and/or the like.

The central server system 108 may function to generate and/or transmit enhanced data 142 from local data 140. Enhanced data 142 may, for example, allow the central server system 108 to store in a central location data configured for receipt by one or more remote target systems, rather than in many disparate formats that would otherwise be unable or more complicated to be received and/or processed by the remote systems. In some embodiments, enhanced data 142 may appear to be associated with a single owner entity, instead of the multiple owner entities associated with the local data 140 used to the generate the enhanced data 142.

In some embodiments, the central server system 108 may filter and/or format local data 140 to generate enhanced data 142. For example, local data 140 may include duplicate entries, and may have a variety of different formats. The central server system 108 may identify and delete duplicate entries and/or remove, anonymize, and/or modify owner entity information. For example, the central server system 108 may modify transaction logs to indicate a single owner entity (e.g., Skupos).

In some embodiments, the central server system 108 may format local data 140, and/or filtered local data, to have a common format (e.g., a normalized XML format). For sake of illustrative clarity, it will be appreciated that functions (e.g., filtering) performed on local data, as described herein, may also be applied to filtered data and vice versa. In some embodiments, the central server system 108 may format the local data 140 based on an intended target system for the local data 140. For example, the local data 140 may include transaction logs for a variety of different retail stores, and the intended target may be a remote Coca-Cola system. The central server system 108 may format that local data 140 according to a specification defined by the target system. For example, the central server system interfaces 144 may include the specifications for various target systems, and the central server system 108 may format each respective subset of local data 140 using the central server system interfaces 144.

The central server system 108 may function to generate reports. As used herein, reports may comprise a particular type of enhanced data 142. For example, reports may include summaries of transactions logs, and the reports may be formatted according to requirements of an intended target system (e.g., a brand system and/or distributor system). In another example, reports may be generated for an owner system (e.g., so the owner may view transaction logs, transaction log summaries, and/or the like). The central server system 108 may generate reports based on local data 140, filtered local data, and/or normalized local data.

The brand systems 110 may function to obtain and process reports and/or other data configured according to their system requirements. For example, a brand system 110 may be associated with Coca-Cola. In some embodiments, the brand systems 110 may use brand interfaces 160 to connect to one or more datastores of the central server system 108 to obtain the enhanced data and/or reports. In another example, the brand systems 110 may provide a request for reports to the central server system 108, and the central server system 108 may generate and provide reports in response to the request. In another example, reports may be provided to brand systems 110 as they are created. In various embodiments, functionality of the brand systems 110 may be performed by one or more servers (e.g., a cloud-based server) and/or other computing devices.

The distributor systems 112 may function to obtain and process reports and/or other data configured according to their system requirements. The distributor systems 112 may obtain and process reports and/or other data in connection with distribution of products (e.g., soda) associated with brands (e.g., Coca-Cola). Products may also be referred to as items. In some embodiments, the distributor systems 112 may use distributor interfaces 170 to connect to one or more datastores of the central server system 108 to obtain reports. In another example, the distributor systems 112 may provide a request for reports to the central server system 108, and the central server system 108 may generate and provide reports in response to the request. In another example, reports may be provided to distributor systems 112 as they are created. In various embodiments, functionality of the distributor systems 112 may be performed by one or more servers (e.g., a cloud-based server) and/or other computing devices.

The owner system 114 may function to manage and/or otherwise interact with remote systems (e.g., client systems 106). For example, an owner entity may own multiple retail stores, and each store may have a client system 106. The owner system 114 may use a remote access interface 150 to establish and/or initiate a secure remote connection with a particular client system 106 to pull transaction logs from associated point of sale systems, view those transactions, request that corresponding reports be generated, and/or the like. The owner system 114 may display information (e.g., reports) via a dashboard and/or other graphical user interfaces. In various embodiments, functionality of the owner system 114 may be performed by one more computing devices (e.g., desktop computer, mobile devices, servers).

The communications network 116 may represent one or more computer networks (e.g., LAN, WAN, or the like) or other transmission mediums. The communication network 116 may provide communication between some or all of the systems, engines, datastores, and/or other features described herein. For example, the communications network 116 may provide communication between the systems 106-114, but not system 102-104 (e.g., because the point of sale systems 102 and 104 may be limited to non-WAN connections). In some embodiments, the communication network 116 includes one or more computing devices, routers, cables, buses, and/or other network topologies (e.g., mesh, and the like). In some embodiments, the communication network 116 may be wired and/or wireless. In various embodiments, the communication network 116 may include the Internet, one or more wide area networks (WANs) or local-area networks (LANs), one or more networks that may be public, private, IP-based, non-IP based, and so forth.

The verified information datastore system 180 may function to store verified information 182 and/or process requests relating to the verified information 182. For example, the verified information datastore system 180 may be a Department of Motor Vehicles (DMV) system, and the verified information 182 may include driver's license information. In some embodiments, the verified information datastore system 180 may be credit bureau (e.g., Equifax) systems, independent data and age validation services (e.g., LexisNexis), and/or the like, and the systems may store related information (e.g., tax identification numbers and/or other information stored by those systems). In various embodiments, functionality of the verified information datastore system 180 may be performed by one or more servers (e.g., a cloud-based server) and/or other computing devices.

In some embodiments, it may be possible for the point of sale systems 102 and/or 104 to communicate over the communication network 116, and for the central server system 108 to communicate directly with the point of sale systems 102 and/or 104 without any intermediate client systems 106. In such embodiments, some or all of the functionality provided at the client systems 106 may be integrated into the central server system 108.

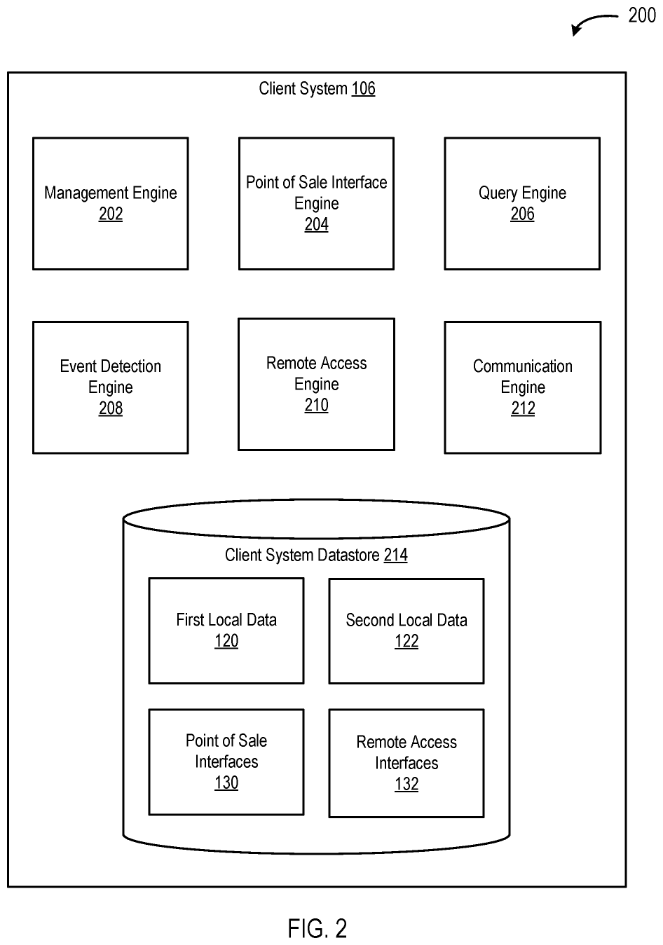

FIG. 2 depicts a diagram of an example client system 106 according to some embodiments. In the example of FIG. 2, the client system 106 includes a management engine 202, a point of sale interface engine 204, a query engine 206, an event detection engine 208, a remote access engine 210, a communication engine 212, and a client system datastore 214.

The management engine 202 may function to manage (e.g., create, read, update, delete, or otherwise access) first local data 120, second local data 122, point of sale interfaces 130, and/or remote access interfaces 132. Any of 120-132 may be stored in the client system datastore 214 and/or other datastore(s) associated with the client system 106. The management engine 202 may perform any of these operations manually (e.g., by a user interacting with a GUI) and/or automatically (e.g., triggered by one or more of the engines 204-212). Like other engines described herein, some or all of the functionality of the management engine 202 may be included in and/or cooperate with one or more other engines (e.g., engines 204-212).

The point of sale interface engine 204 may function to access point of sale systems. For example, the point of sale interface engine 204 may use HTTP protocols to access first point of sale systems 102 and/or second point of sale systems 104 over a LAN connection. In some embodiments, the point of sale interface engine 204 may access point of sale systems using point of sale interfaces 130. For example, the point of sale interfaces 130 may include APIs, file system protocols, authentication information for logging into the point of sale systems, and/or the like.

In some embodiments, authentication information may include credentials specific to a point of sale system (e.g., Verifone username and password) and/or operating system credentials (e.g., a Windows username or password). The point of sale interface engine 204 may authenticate information defined in a point of sale interface 130 against a point of sale system. In some embodiments, a cookie or other session token may be generated, which may be renewed and/or refreshed by the point of sale interface engine 204 to maintain a persistent (or, semi-persistent) connection between a client system and one or more point of sale systems.

In some embodiments, the query engine 206 may function to obtain local data from point of sale systems. For example, the query engine 206 may obtain first local data 120 from a connected first point of sale system 102 over a local-area network connection, and second local data 122 from a second point of sale system 104 over a local-area network connection. In some embodiments, the point of sale interface engine 204 may periodically pull local data from point of sale systems. For example, the point of sale interface engine 204 may pull local data every 15 minutes and/or other predetermined period and/or schedule. In one example, the query engine 206 system may pull first local data 120 corresponding to chunk of time (e.g., an 8 hour shift) every 15 minutes. This may result in redundant data which the central server system may filter, as discussed elsewhere herein.

The query engine 206 may function to obtain local data on-demand. For example, the query engine 206 may receive a request to pull local data. The request may include a client system identifier (e.g., computer name, MAC address, an IP address), a retail store identifier (e.g., name or other identifier), a type of transaction (e.g., sale transaction), a point of sale identifier (e.g., system ID number, IP address, MAC address), transaction log file names, and/or desired time and date ranges. In some embodiments, point of sale systems may not store local data according to time and/or data ranges. Accordingly, the query engine 206 may generate a query based on a desired time and/or data range. For example, the request may include “August 2017,” and the query engine 206 may generate a request for transaction log files having a file name including “August” and “2017.” In another example, query engine 206 may search content of local data for field values having “August” or “2017,” and/or corresponding numerical information (e.g., Aug. 15, 2017).

The query engine 206 may function to obtain local data in response to an event. In some embodiments, the event detection engine 208 may function to detect events in file system-based point of sale systems (e.g., point of sale systems 104). For example, the query engine 206 may listen for, and/or detect, a create event (or other file system event). In response to detecting the create event, the detection engine 208 may notify the query engine 206 to connect directly to the file system folder containing the created data (e.g., second local data), and pull the data. This may, for example, ensure that data is pulled immediately after being generated, and may also reduce and/or prevent duplicate data.

The remote access engine 210 may function to receive and/or establish secure remote access connections. For example, the remote access engine 210 may function to receive and/or establish virtual private network connections. The secure remote access connections may allow a remote user to interact with the client system 106 as if the remote user were on site at the location of the client system 106. In some embodiments, the remote access engine 210 may use a remote access interface 132 to cooperate with a corresponding remote access interface on a remote system to establish and/or maintain the secure remote access connection.

The communication engine 212 may function to send requests, transmit and, receive communications, and/or otherwise provide communication with one or a plurality of the systems, engines, and/or datastores described herein. In some embodiments, the communication engine 212 functions to encrypt and decrypt communications. The communication engine 212 may function to send requests to and receive data from one or more systems through a network or a portion of a network. Depending upon implementation-specific considerations, the communication engine 212 may send requests and receive data through a connection, all or a portion of which may be a wireless connection. The communication engine 212 may request and receive messages, and/or other communications from associated systems and/or engines. Communications may be stored in the client system datastore 214.

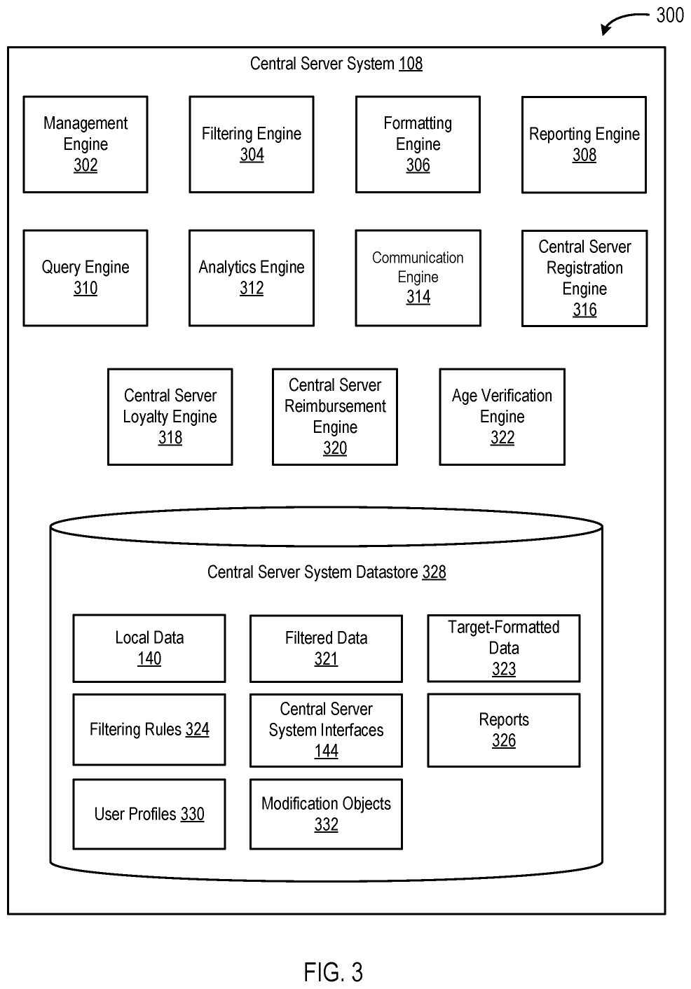

FIG. 3 depicts a diagram of an example central server system 108 according to some embodiments. In the example of the FIG. 3, the central server system 108 includes a management engine 302, a filtering engine 304, a formatting engine 306, a reporting engine 308, a query engine 310, an analytics engine 312, a communication engine 314, a central server registration engine 316, central server loyalty engine 318, a central server reimbursement engine 320, an age verification engine 322, and a central server system datastore 328.

The management engine 302 may function to manage (e.g., create, read, update, delete, or otherwise access) local data 140, filtered data 321, target-formatted data 323, filtering rules 324, central server system interfaces 144, reports 326, user profiles 330, and/or modification objects 332, any of which may be stored in the central server system datastore 328 and/or other datastore(s) associated with the central server system 108. In some embodiments, the filtered data 321, the target-formatted data 323, and/or the reports 326 may be referred to as enhanced data. The management engine 302 may perform any of these operations manually (e.g., by a user interacting with a GUI) and/or automatically (e.g., triggered by one or more of the engines 304-314). Like other engines described herein, some or all of the functionality of the management engine 302 may be included in and/or cooperate with one or more other engines (e.g., engines 304-314).

The filtering engine 304 may function to filter local data 140 to generate filtered data 321. Local data 140 may include first local data 120 and/or second local data 122. Accordingly, the local data 140 may include tabular data, e.g., a column indicating an owner entity identifier, a column indicating a consumer entity, a column indicating a product identifier (e.g., UPC code), a column indicating a store identifier (e.g., a retail store identifier), and/or the like. The filtering engine 304 may filter local data 140 to remove duplicate data entries, and/or remove particular entries and/or particular fields (e.g., columns of tabular data). For example, the filtering engine 304 may remove columns indicating an entity owner. In another example, the filtering engine may modify values associated with an entity owner identifier to a common value (e.g., “Skupos”). Similar functionality may be included in the reporting engine 308, discussed further herein, to similarly modify, filter, and/or generate reports (e.g., so that reports 326 may appear to associated with a single owner entity).

In some embodiments, the filtering engine 304 may identify duplicate entries based on direct field matches and/or direct field value matches. For example, the filtering engine 304 may compare tables, columns, and/or rows, and if there is an exact match, the filtering engine 304 may identify a duplicate and merge the entries and/or delete duplicates until there are no more duplicates remaining. In some embodiments, the filter engine 304 may infer duplicates. For example, local data may be obtained in different formats, and it may appear that entries are different when in fact they are duplicates. The filtering engine 304 may normalize the local data prior to identifying the duplicates, as the normalization may surface duplicates that would otherwise appear different (e.g., because they are in different formats prior to the normalization).

In some embodiments, the filtering engine 304 may filter local data 140 based on filtering rules 324. The filtering rules 324 may define rules for removing and/or modifying fields (e.g., columns, rows, tables) and/or field values, identifying duplicate entries, resolving duplicate entries, and/or the like. The filtering rules 324 may also be associated with particular point of sale systems. For example, a first set of rules 324 may be associated with a first point of sale system 102 and a second set of rules 324 may be associated with a second point of sale system 104. The first set of rules may be configured for a primarily pull-based client system, which can cause many duplicate entries, and the second set of rules 324 may be configured for a primarily event-based client system, which may cause fewer duplicate entries. For example, the first set of rules 324 may cause the filtering engine 304 to identify and resolve duplicates for all obtained local data obtained from a first point of sale system 102, but only identify and resolve duplicates for a particular subset of local data obtained from a second point of sale system 104. For example, if the second point of sale system 104 obtained the local data in response to detecting an event, the filtering engine 304 may not check for duplicates, although the filtering engine 304 may check for duplicates if the second point of sale system 104 obtained the local data in response to a periodic pull.

The formatting engine 306 may function to format local data 140 and/or filtered data 321 to generate target-formatted data 323. In some embodiments, the formatting engine 306 may normalize data (e.g., local data 140 and/or filtered data 321), and format the normalized data to generate the target-formatted data 323. The formatting engine 306 may generate target-formatted data 323 based on requirements of one of one or more remote target system and/or entities associated therewith (e.g., Coca-Cola). In some embodiments, the formatting engine 306 may use central server system interfaces 144 to generate target-formatted data 323. For example, the central server system interfaces 144 may define requirements for structuring data (e.g., table structure, field names, data types, values, and/or the like), amount of data to include, a particular XML structure, and/or the like, associated with particular remote systems.

In some embodiments, the formatting engine 306 may parse local data 140 and/or filtered data 321 to parse out specific data required and/or excluded by a remote target system (e.g., as defined by a central server system interface 144). For example, the formatting engine 306 may parse data to select and/or exclude owner entity identifiers, consumer entity identifiers, product identifiers (e.g., UPC codes), store identifiers, and/or the like.

The reporting engine 308 may function to generate reports 326. For example, reports 326 may comprise transactions logs, summaries of transactions logs, and/or the like. Summaries may include information describing a set of transactions logs (e.g., total transaction amounts, transaction amount averages, transaction trends, and/or the like). Reports 326 may be configured by the reporting engine 306 for receipt by a remote target system. Reports 326 may be configured to be provided to brand systems, distributor systems, owner systems, and/or other systems. Reports may be configured to appear as if they are associated with a single entity.

In some embodiments, the reporting engine 308 receives a request for a report, e.g., from a brand or from a distributor. For example, a distributor may want to want to know how many items were sold in the state of Oregon and/or in a northwest region of the United States, and the corresponding report may indicate that information in one or more varying levels of granularity and/or in the format defined in the interface associated with the target system. In some embodiments, the report request may specify one or more variables, e.g., manufacturer, brand, product type, product category, retail store identifier, geographic location, and/or specific set of uniform product codes (UPCs). The reporting engine 308 may generate a report based on the request. The report may be based on the relevant subset of the local data 140 and/or filtered local data 321.

The query engine 310 may function to obtain local data 140. The query engine 310 may use web sockets to communicate and/or instruct client systems. The query engine 310 may instruct a client system to pull local data from a connected point of sale system. The query engine 310 may obtain local data in response to receiving a request for local data from a remote system. In some embodiments, the query engine 310 functions to process requests. For example, the query engine 310 may function to process requests for previously generated and/or stored reports 326, and/or generate new reports 326.

The analytics engine 312 may function to analyze local data 140, filtered data 321, target-formatted data 323, and/or reports 326. In some embodiments, the analytics engine 312 may determine dates and/or times that a retail store is closed. For example, the analytics engine 312 may analyze local data 140 and determine that local data for Sundays are always empty, and the analytics engine 312 may determine that the store associated with that local data is closed on Sundays. In some embodiments, this may cause the central server system 108 to update when a corresponding client system pulls local data from the point of sale system(s) in that store (e.g., only pull data on Monday through Saturday).

The communication engine 314 may function to send requests, transmit and, receive communications, and/or otherwise provide communication with one or a plurality of the systems, engines, and/or datastores described herein. In some embodiments, the communication engine 314 functions to encrypt and decrypt communications. The communication engine 314 may function to send requests to and receive data from one or more systems through a network or a portion of a network. Depending upon implementation-specific considerations, the communication engine 314 may send requests and receive data through a connection, all or a portion of which may be a wireless connection. The communication engine 314 may request and receive messages, and/or other communications from associated systems and/or engines. Communications may be stored in the central server system datastore 328.

In some embodiments, the communication engine 314 obtains local data 140 from client systems over a communication network. For example, the communication engine 314 may obtain local data 140 pushed to the central server system 108 from the clients systems, and/or pull data from client systems (e.g., in response to query generated and/or processed by the query engine 310).

The central server registration engine 316 may function to register users. For example, the central server registration engine 316 may create, read, update, and/or delete user profiles 330. User profiles 330 may include some or all of the following information:
User Profile Identifier: identifies the user profile.
User Identifier: identifies the user (e.g., a phone number)
Contact Information: contact information for the user, such as mailing address, email address, phone number.
Loyalty Programs: Currently registered loyalty programs.
Loyalty History: rewards previously received.
Transaction History: Transaction history for transactions that include rewards, and/or transaction that do not include rewards.
Age Verification Information: A secure identifier (e.g., a driver's license). The age verification information may include a scanned image, a photograph, code, and/or the like. For example, the secure identifier may comprise a photograph and/or other portion of the of the user's driver's license (e.g., driver's license number).

In some embodiments, the central server registration engine 316 functions to register users with the central server system 108 and/or remote systems (e.g., brand systems 110). For example, the central server registration engine 316 may function to register users for one or more loyalty programs. In some embodiments, a loyalty program may refer to a set of one or more retailer-agnostic modification objects (or, simply, “modification objects”). For example, a loyalty program may comprise rewards related to two-liter bottles of Coca-Cola, and the modification objects for that program may have varying attributes (e.g., different reward rules). In some embodiments, a modification object, as used herein, may define one or more rewards. Accordingly, a reward as used herein, may refer to a modification object, and/or vice versa.

In some embodiments, users must be registered in order to be eligible to receive rewards. For example, a user may provide their user identifier to a point of sale system and/or related system, and the central server system 108 may determine whether the user is registered. If the user is registered, the central server system may use their user profile 330 to determine whether the user is eligible for a reward. If the user is not registered, it may prompt and/or otherwise instruct the user to register with the central server system 108 and/or remote systems (e.g., brand system 110).

The central server loyalty engine 318 may function to obtain (e.g., pull), manage, provide (e.g., push), and/or generate modification objects 332 and/or modification objects 932. Some or all operations may be performed in real-time. Modification objects 332 may refer to modification objects that are created and/or managed by the central server loyalty engine 318. Modification objects 932 may refer to modification objects that are created and/or managed by a brand system (e.g., brand system 110), and routed by the central server system 108. For example, the central server loyalty engine 318 may provide a central location for routing modification objects 932 from brand systems to remote systems (e.g., client systems 106, point of sale systems 102). The central server loyalty engine 318 may use server interfaces 144 (e.g., APIs) for communicating and/or cooperating with brand systems (e.g., via brand interfaces 160).

In some embodiments, modification objects 332 may comprise rewards of a loyalty program. Rewards may include discounts (e.g., 50% discount, $5 discount), credits (e.g., buy 10 items and get 1 free), points (e.g., accrue 100 points, and get 1 item free), and/or other offers (e.g., two-for-one, buy two items and get a third item for 50% off). Loyalty programs may be brand-specific and/or retailer-specific.

In some embodiments, a modification object 332 may include some or all of the following information:
Reward Identifier: identifies the modification object and/or reward.
Item(s): items and/or item data (e.g., UPC codes) of items eligible for the reward.
Retailer(s): retailer where the reward may be redeemed (e.g., Joe's Store and John's Store).
Reward Rules: Specifies eligibility requirements, and/or the particular reward (e.g., 50% off).
Geographic Locations: particular geographic locations (e.g., states, cities, neighborhoods) associated with the modification object and/or reward.
Dates: particular dates (e.g., certain days, months, or times of day) associated with the modification object and/or reward (e.g., when the reward may be offered and/or redeemed).
Users: For example, specific users eligible for reward, or user-specific rewards.

The central server reimbursement engine 320 may function to provide and/or facilitate reimbursements associated with modification objects. For example, the central server registration engine 320 may report transaction information including reward information to a brand system, and the brand system may reimburse retailers. Transaction information may include transaction amount indicating a reimbursement amount (e.g., $2), and that may be provided to the brand systems in real-time and/or periodically (e.g., monthly, along with other transaction information of other transactions). In another example, the central server registration engine 320 may remit payment to the retailers, and then generate and provide an invoice to brand systems for reimbursement to the central server system 108. Invoices may be generated and/or provided in real-time and/or periodically.

The age verification engine 322 may function to determine whether an item is age-restricted. For example, age-restricted items may include tobacco and/or alcohol. In some embodiments, the filtering rules 324 may indicate items and/or item data that is age-restricted, and/or may indicate the age restriction (e.g., 18 years old, 21 years old). In some embodiments, embodiments, the age verification engine 322 cooperates with a remote system (e.g., a brand system 110) to determine whether an item is age restricted. For example, the remote system may maintain a list of age restricted items and their age restrictions, and the age verification engine 322 may obtain that information from the remote system (e.g., using server interfaces 144 and/or brand interfaces 160).

In one example, a user may attempt to purchase an age-restricted product (e.g., tobacco, alcohol). The age verification engine 322 may determine whether the user is eligible to purchase the age restricted product (e.g., over 18 years old, over 21 years old). For example, the age verification engine 322 may obtain a secure user identifier (e.g., a driver's license number) for the user, and then access a verified information datastore system (e.g., a Department of Motor Vehicles database system) to determine whether the secure user identifier is authentic. If the secure user identifier indicates an eligible age (e.g., over 18 years old, over 21 years old), and if the secure user identifier is determined to be authentic, the age verification engine 322 may authorize the purchase. Otherwise, the age verification engine 322 may deny the purchase. For example, a corresponding point of sale system (e.g., a point of sale system 102) may be unable to complete a purchase if the user is determined to be underage and/or if the secure user identifier is not authentic. Accordingly, a clerk at a retailer may be prevented at the point of sale system from selling age-restricted products to a minor, even if the clerk tried to complete the purchase.

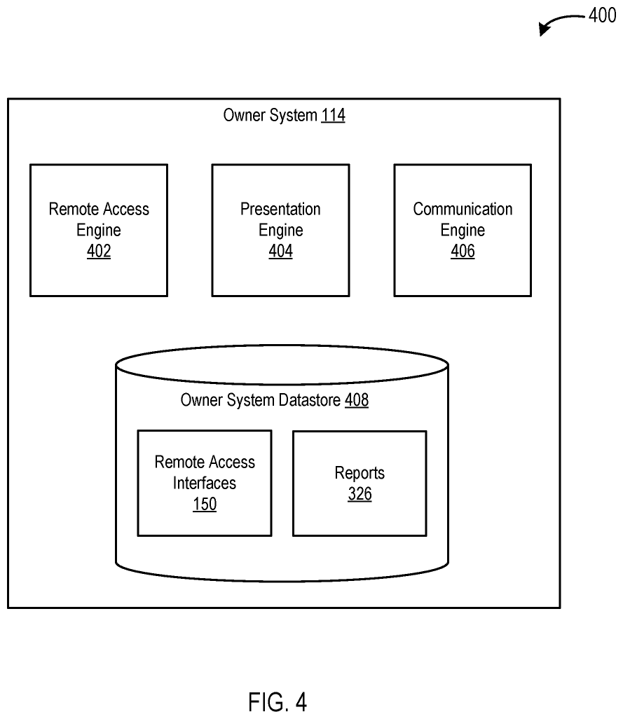

FIG. 4 depicts a diagram of an example owner system 114 according to some embodiments. In the example of the FIG. 4, the owner system 114 includes a remote access engine 402, a presentation engine 404, a communication engine 406, and an owner system datastore 408.

The remote access engine 402 may function to establish secure remote connections with one or more client systems. In some embodiments, the remote access engine 402 uses remote access interfaces 150 to establish secure remote connections. For example, the remote access engine 402 may establish a virtual private network connection with one or more client systems in one or more locations.

The presentation engine 404 may function to present and/or display one or more dashboards and/or graphical user interfaces. For example, a dashboard may allow a user (e.g., entity owner) to view reports 326, request reports 326, view local data on client systems, request client systems to obtain local data from point of sale systems, and/or the like.

The communication engine 406 may function to send requests, transmit and, receive communications, and/or otherwise provide communication with one or a plurality of the systems, engines, and/or datastores described herein. In some embodiments, the communication engine 406 functions to encrypt and decrypt communications. The communication engine 406 may function to send requests to and receive data from one or more systems through a network or a portion of a network. Depending upon implementation-specific considerations, the communication engine 406 may send requests and receive data through a connection, all or a portion of which may be a wireless connection. The communication engine 406 may request and receive messages, and/or other communications from associated systems and/or engines. Communications may be stored in the owner system datastore 408.

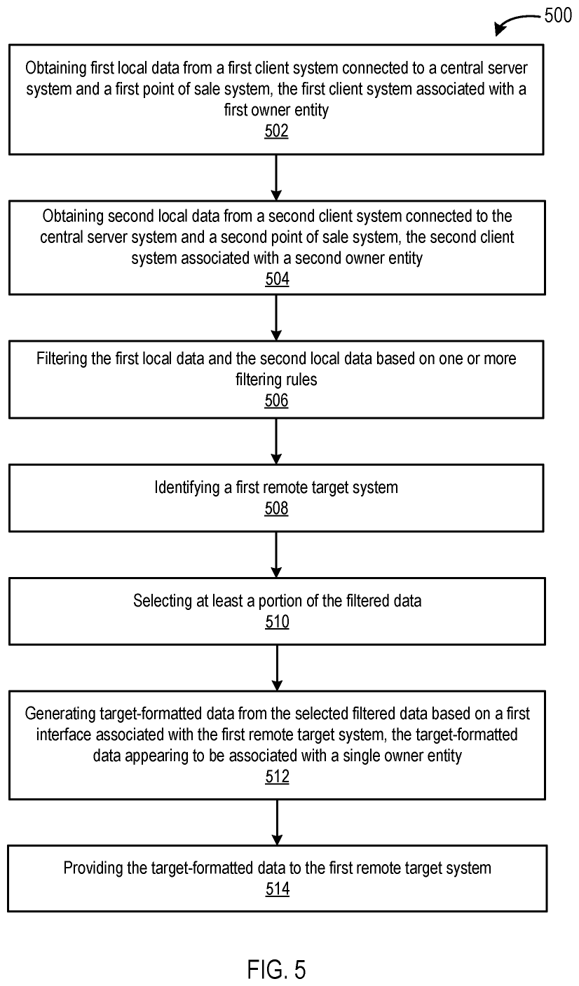

FIG. 5 depicts a flowchart of an example of a method 500 of operation of a central server system according to some embodiments. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 502, a central server system (e.g., central server system 108) obtains first local data (e.g., first local data 120) from a first client system (e.g., client system 106-1) connected to the central server system via a wide-area network (e.g., communications network 116). The first local data may be generated by a first point of sale system (e.g., first point of sale system 102) connected to the first client system via a first local-area network (e.g., a direct cable connection). For example, the first point of sale system may be a Verifone point of sale system located in a retail store (e.g., “Joe's Store”) owned by a first owner entity (e.g., “Joe Smith”). The first local data may be obtained from the first point of sale system by the first client system via the first LAN. The first local data may be generated by the first point of sale system according to a first data format. For example, the first data format may be a mark-up language format (e.g., XML), a data format associated with Verifone point of sale systems, and/or the like. The first data format may be a tabular format, object-oriented format, and/or the like. In some embodiments, a query engine (e.g., query engine 314) and/or a communication engine (e.g., communication engine 314) obtains the first local data from the first client system.

In some embodiments, the first local data is obtained by the first client system using one or more application programming interfaces (APIs) associated with the first point of sale system. For example, the first client system may use one or more Verifone APIs to hook into the first point of sale system (e.g., as opposed to a file system that may be accessed using operating system protocols) to obtain the first local data from the first point of sale system.

In some embodiments, the first local data is obtained in response to a periodic pull request generated by the first client system and/or the central server system. For example, the first client system may pull first local data corresponding to chunk of time (e.g., an 8 hour shift) every 15 minutes. This may result in redundant (or, “duplicate”) data which the central server system may filter, as discussed elsewhere herein.

In some embodiments, the first local data is obtained in response to a periodic pull request during a persistent authenticated session between the first client system and the first point of sale system. For example, the first client system may log-in with credentials associated with the first point of sale system which may be authenticated against the first point of sale system by the first point of sale system. A cookie or other session token may be renewed or refreshed by the first client system to maintain a persistent connection between the first client system and the first point of sale system. In some embodiments, a point of sale interface engine (e.g., point of sale interface engine 204) performs log-ins, authentications, and/or maintains the persistent connection.

In step 504, the central server system obtains second local data (e.g., second local data 122) from a second client system (e.g., client system 106-N) connected to the central server system via the WAN. The second local data may be generated by a second point of sale system (e.g., second point of sale system 104) connected to the second client system via a second LAN (e.g., a direct cable connection). For example, the second point of sale system may be a Gilbarco point of sale system located in another retail store (e.g., “John's Store”) owned by a second owner entity (e.g., “John Doe”). The second local data may be obtained from the second point of sale system by the second client system via the second LAN. The second local data may be generated by the second point of sale system according to a second data format. For example, the second data format may be a mark-up language format (e.g., XML), a data format associated with Gilbarco point of sale systems, and/or the like. The second data format may be a tabular format, object-oriented format, and/or the like. The second data format be different and/or the same as the first data format. In some embodiments, the query engine and/or the communication engine obtains the second local data from the second client system.

In some embodiments, the second client system obtains the second local data using a file system (e.g., a Windows file systems) associated with the point of sale system. For example, the second client system may listen for, and/or detect, a create event (or other file system events and/or operating systems events). In response to detecting the create event, the second client system may connect directly to the file system folder containing the created data (e.g., second local data), and pull the local data. This may, for example, ensure that local data is pulled immediately after being generated, and also may reduce and/or prevent duplicate data.

In some embodiments, the second local data is obtained during a persistent authenticated session between the second client system and the second point of sale system. For example, the second client system may log-in to the second point of sale system using operating systems credentials (e.g., username and password of the Windows computer implementing second point of sale system) associated with the second point of sale system. A cookie or other session token may be renewed or refreshed by the second client system to maintain a persistent connection between the second client system and the second point of sale system. In some embodiments, the point of sale interface engine performs log-in, authentication, and/or maintains the persistent connection.

In some embodiments, the first point of sale system and/or the second point of sale system are not capable of WAN connections. For example, the first and second point of sale systems may only have cable connections for direct local-area networking.

In step 506, the central server system filters the first local data and the second local data based on one or more filtering rules (e.g., filtering rules 324) associated with the first point of sale system and the second point of sale system. For example, filtering may include removing duplicate data entries from the first local data caused by a periodic pull used by the first client system to obtain the first local data from the point of sale system. In some embodiments, a filtering engine (e.g., filtering engine 304) filters the first and second local data of local data (e.g., local data 140) stored in a central server system datastore (e.g., central server system datastore 328).

In step 508, the central server system identifies a first remote target system (e.g., a brand system 110 or a distributor system 112). For example, the central server system may identify the first remote target system based on a request for data (e.g., a report) by the first remote target system and/or other system associated with a same entity as the first remote target system. For example, the central server system may identify a Coca-Cola target system in response to receiving a request for a report by the Coca-Cola target system and/or other Coca-Cola system. In some embodiments, the filtering engine and/or a reporting engine (e.g., reporting engine 308) identifies the first remote target system.

In step 510, the central server system selects at least a portion of the filtered data (e.g., filtered data 321). The selected filtered data may include filtered data associated with the first owner entity and other filtered data associated with the second owner entity. In some embodiments, the filtering engine and/or reporting engine selects the filtered data (e.g., based on a request for a report). For example, in some embodiments, the request specifies one or more variables, e.g., manufacturer, brand, product type, product category, retail store identifier, geographic location, and/or specific set of uniform product codes (UPCs), and the at least a portion of the filtered data is selected based on the variables specified. The central server system selects the relevant subset of the local data 140 and/or filtered local data 321. For example, a distributor may want to want to know how many items were sold in the state of Oregon and/or in a northwest region of the United States. The request may identify a geographic region (e.g., particular state, county, town, and/or sets thereof), and the relevant subset of local or filtered data may be selected based on the geographic region. The corresponding report may indicate the information in one or more varying levels of granularity.

In step 512, the central server system generates target-formatted data (e.g., target-formatted data 323) from the selected filtered data based on a first interface (e.g., central server system interface 144) associated with the first remote target system. For example, the first interface may define format requirements (e.g., data types, table structures, field names, object properties) for data (e.g., reports) sent to the remote target system. The target-formatted data may have a third data format associated with the first remote target system. The third data format may be a tabular format, object-oriented format, and/or the like. The third data format be different and/or the same as the first and/or second data formats. The target-formatted data may appear to be associated with a single owner entity (e.g., a “Skupos” entity). This may, for example, allow the remote target system to receive and/or process local data generated by many different and disparate point of sale systems that otherwise would not be provided to the remote target system. In some embodiments, a formatting engine (e.g., formatting engine 306) generates the target-formatted data.

In step 514, the central server system provides the target-formatted data to the first remote target system. In some embodiments, the communication engine provides the target-formatted data over the WAN using the first interface and/or other interface associated with the remote target system. For example, the first interface may define one or more communication protocols (e.g., APIs) for the remote target system.

In some embodiments, a client system may be connected to multiple point of sale systems and obtain local data from multiple point of sale systems. For example, the central server system may obtain third local data from the first client system connected to the central server system via the WAN. The third local data may be generated by a third point of sale system (e.g., a Verifone system or a Gilbarco system) connected to the first client system via the first LAN. The third point of sale system may be associated with the first owner entity, and the third local data being may be obtained from the third point of sale system by the first client system via the first LAN. The third local data may be generated by the third point of sale system according to the first data format. The central server system may filter the third local data, and generate a first report (e.g., report 326) associated with the first and third filtered local data. The central server system may provide the first report to an owner system (e.g., owner system 114). For example, the central server system may generate a report summarizing transactions processed by the first and third point of sale systems. In some embodiments, the reporting engine generates the report.

In some embodiments, the central server system obtains fourth local data from a third client system connected to the central server system via the WAN. The fourth local data may be generated by a fourth point of sale system (e.g., a Verifone or Gilbarco point of sale system) connected to a third client system via a third LAN. The fourth point of sale system may associated with the first owner entity (e.g., located in another retail store owned by Joe Smith). The fourth local data may be obtained from the fourth point of sale system by the fourth client system via the third LAN. The fourth local data may be generated by the fourth point of sale system according to the second format. The central server system may filter the fourth local data (e.g., in the same or similar manner as the first, second, and/or third local data). The central server system may also generate a second report (e.g., report 326) associated with the first filtered local data, the third filtered local data, and the fourth filtered local data, and provide the second report to the owner system. For example, the second report may be generated in response to a query received from the owner system. The query may be processed by a query engine (e.g., query engine 310), and the query engine may trigger the reporting engine to generate the second report.

In some embodiments, the central server system may provide information to different remote target systems. For example, the central server system may provide information to other brand and/or distributor systems using interfaces particular to the respective brand and/or distributor systems. Accordingly, the central server system may identify a second remote target system (e.g., a Pepsi system) and select at least a second portion of the filtered data. The second portion of filtered data may be associated with the first point of sale system, the second point of sale system, the third point of sale system, and/or the fourth point of sale system. The central server system may generate second target-formatted data from the second portion of filtered data based on a second interface associated with the second remote target system (e.g., an interface associated with Pepsi). The second target-formatted data may have a fourth data format associated with the second remote target system. The fourth data format may be a tabular format, object-oriented format, and/or the like. The fourth data format be different and/or the same as the first, second, and/or third data formats. The second target-formatted data may appear to be associated with the single owner entity. The central server system may provide the second target-formatted data to the second remote target system.

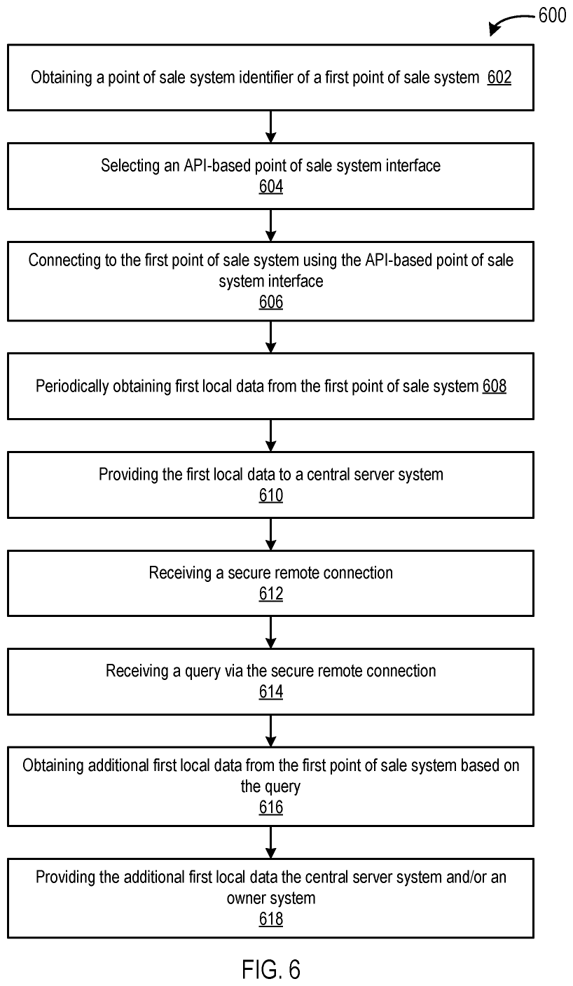

FIG. 6 depicts a flowchart of an example method 600 of operation of a client system connected to an API-based point of sale system according to some embodiments.

In step 602, a client system (e.g., client system 106-1) obtains a point of sale system identifier of a first point of sale system (e.g., first point of sale system 102). For example, the point of sale system identifier may be an Internet Protocol (IP) address. In some embodiments, a point of sale interface engine (e.g., point of sale interface engine 204) obtains the identifier of the first point of sale system. For example, a user may select and/or input an IP address through a graphical user interface presented to the user via the point of sale interface engine.

In step 604, the client system selects an API-based point of sale system interface (e.g., a point of sale interface 130). For example, the API-based point of sale system interface may be configured to hook into a first client system (e.g., first client system 102). In some embodiments, the point of sale interface engine selects the interface.

In step 606, the client system connects to the first point of sale system using the API-based point of sale system interface. In some embodiments, the point of sale interface engine and/or a communication engine (e.g., communication engine 212) connects to the first point of sale system over a LAN connection (e.g., a direct cable connection and/or a local Wi-Fi connection).

In step 608, the client system periodically obtains first local data (e.g., first local data 120). In some embodiments, a query engine (e.g., query engine 206) periodically obtains (e.g., every 15 minutes) the first local data over the LAN connection.

In step 610, the client system provides the first local data to a central server system (e.g., central server system 108). In some embodiments, the query engine and/or the communication engine provides the first local data to the central server system in response to obtaining the first local data and/or in one or more batches.

In step 612, the client system receives a secure remote connection. For example, the secure remote connection may comprise a virtual private network (VPN) connection between the client system and an owner system (e.g., owner system 114). A remote access engine (e.g., remote access engine 210) may receive the secure remote connection The secure remote connection may be a VPN connection and may be facilitated by a remote access interface (e.g., remote access interface 132). The secure remote connection may be between the client system and an owner system (e.g., owner system 114).

In step 614, the client system receives a query via the secure remote connection. For example, the client system may receive the query from the owner system. The query may be for particular first local data (e.g., first local data 120). For example, the query may be for a first local data having an associated file name corresponding to a particular date (e.g., August). In some embodiments, the query engine and/or the communication engine receives the query.

In step 616, the client system obtains additional first local data from the first point of sale system based on and/or in response to the query. In some embodiments, the point of sale interface engine and/or communication engine obtains the additional first local data in response to triggering from query engine.

In step 618, the client system provides to the additional local data to the owner system and/or the central server system. For example, the client system may provide the additional local data to the central server system for filtering, formatting, and/or generating a corresponding report, and the central server system may be provide some or all of that information to the owner system. In some embodiments, the query engine and/or the communication engine provide the additional first local data to the owner systems and/or the central server system over a communications network (e.g., communications network 116).

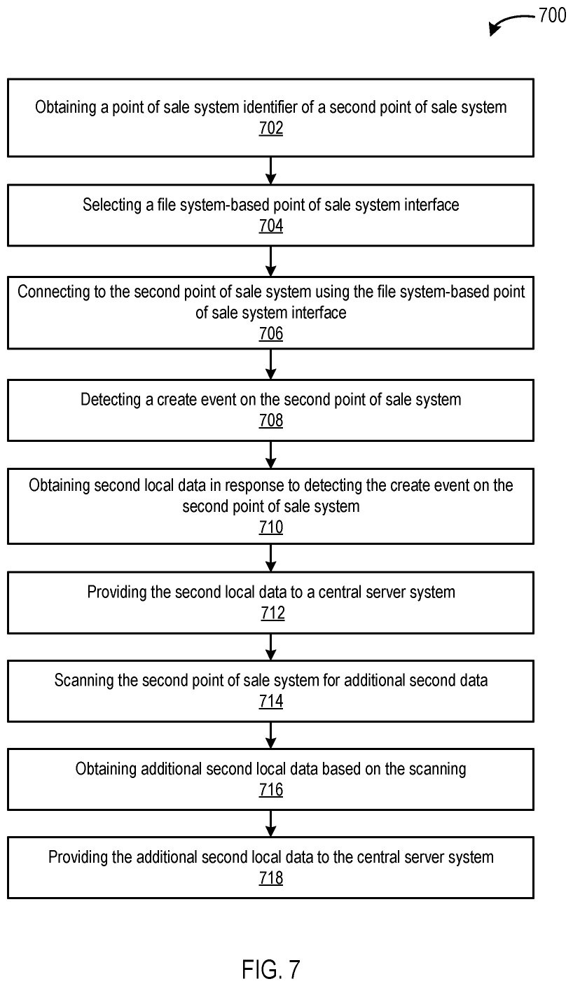

FIG. 7 depicts a flowchart of an example method 700 of operation of a client system connected to a file system-based point of sale system according to some embodiments.

In step 702, a client system (e.g., client system 106-N) obtains a point of sale system identifier of a second point of sale system (e.g., second point of sale system 104). In some embodiments, a point of sale interface engine (e.g., point of sale interface engine 204) obtains the identifier (e.g., an IP address).

In step 704, the client system selects a file system-based point of sale system interface (e.g., point of sale system interface 130). The file system-based interface may define authentication credentials (e.g., username and password) for accessing an operating system (e.g., Windows) of the computing device implementing the second point of sale system. In some embodiments, the point of sale interface engine selects the file system-based point of sale system interface.

In step 706, the client system connects to the second point of sale system using the file system-based interface. In some embodiments, the point of sale interface engine and/or a communication engine (e.g., communication engine 212) connects the client system to the second point of sale system over a LAN.

In step 708, the client system detects a create event on the second point of sale system. In some embodiments, an event detection engine (e.g., event detection engine 208) detects the create event.

In step 710, the client system obtains second local data (e.g., second local data 122) from a file system associated with the second point of sale system in response to detecting the create event. For example, the client system may obtain the local data from a Windows folder and/or directory. In some embodiments, a query engine (e.g., query engine 206) cooperating with the point of sale interface engine and/or the communication engine obtains the second local data over the LAN.

In step 712, the client system provides the second local data to a central server system (e.g., central server system 108) in response to obtaining the second local data. In some embodiments, the query engine and/or the communication engine provides the second local data to the central server system over a communication network (e.g., communications network 116).

In step 714, the client system scans the second point of sale system for additional second data. For example, the client system may scan at least a portion of the file system associated with the second point of sale system for additional second local data (e.g., missing data). For example, the client system may scan periodically (e.g., every 15 minutes). In some embodiments, the query engine scans the second point of sale system. Missing data may be determined by the central server system and may be expected data. For example, local data may be determined to have missing data if the local data has substantially fewer entries (e.g., a threshold number of few entries and/or ratio of fewer entries) entries than related entries (e.g., earlier entries on the same day of the week).

In step 716, the client system obtains additional second local data in response to, and/or based on, the scanning. In some embodiments, the query engine obtains the additional second local data.

In step 718, the client system provides the additional second local data to the central server system based on, and/or in response to, obtaining the additional second local data. In some embodiments, the query engine and/or communication engine provide the additional second data to the central server system.

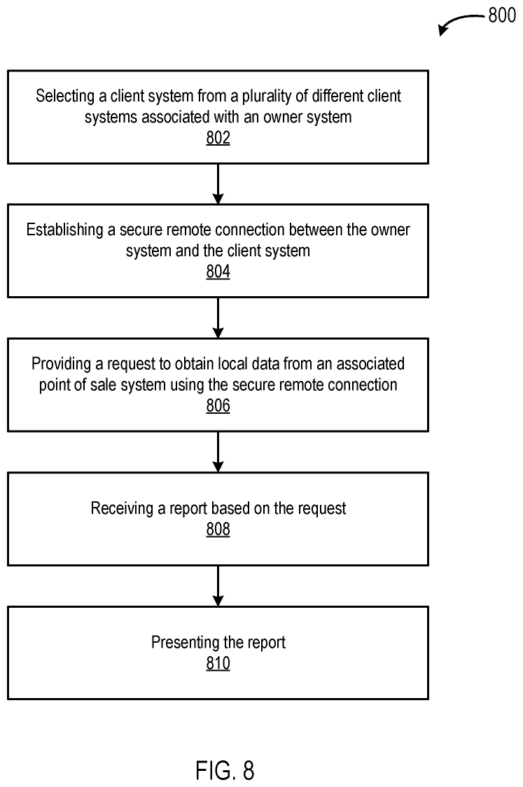

FIG. 8 depicts a flowchart of an example method 800 of an owner system according to some embodiments.

In step 802, an owner system (e.g., owner system 114) selects a client system (e.g., client system 106) from a plurality of different client systems associated with the owner system. For example, a presentation engine (e.g., presentation engine 404) may generate a GUI displaying a menu of client systems associated (e.g., owned and/or operated) with an owner entity, and the owner entity may select the client system. Each of the available client systems may be in different locations and/or different retail stores.

In step 804, the owner system establishes a secure remote connection with the client system. In some embodiments, a remote access engine (e.g., remote access engine 402) uses a remote access interface (e.g., remote access interface 150) to establish the secure remote connections.

In step 806, the owner system provides a request to obtain local data (e.g., local data 120 and/or local data 122) from an associated point of sale system (e.g., first point of sale system 102 or second point of sale system 104) using the secure remote connection. In some embodiments, owner systems generates and provides a request for a report (e.g., report 326). In some embodiments, a communication engine (e.g., communication engine 406) may generate and/or provide the request.

In step 808, the owner system receives a report (e.g., report 326) based on, and/or in response to, providing the request. For example, the communication engine may receive the report from a central server system (e.g., central server system 108).

In step 810, the owner system presents the report. In some embodiments, the presentation engine presents the report. For example, the presentation engine may generate and/or present a dashboard and/or other GUI presenting the report.

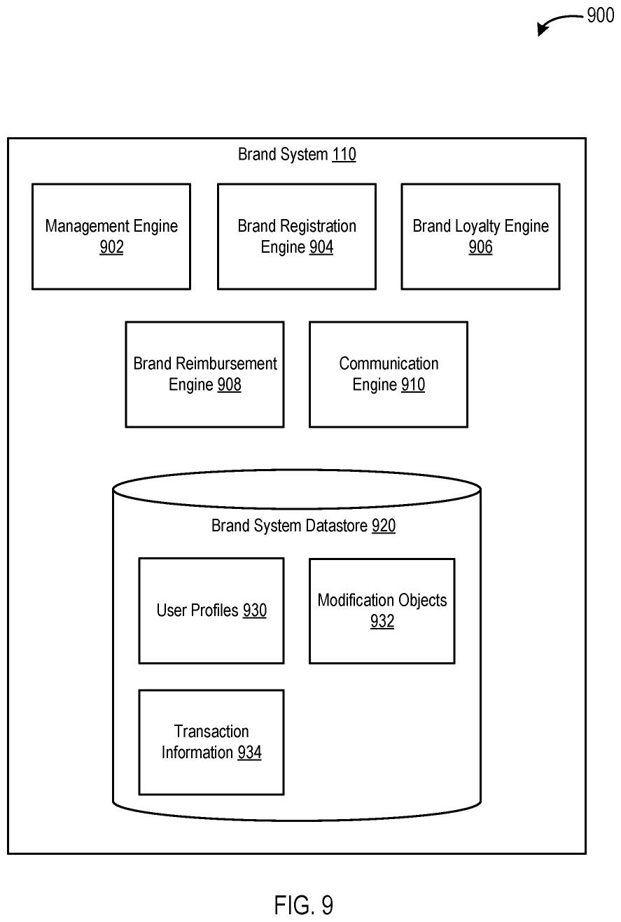

FIG. 9 depicts a diagram of an example of a brand system 110, according to some embodiments. In the example of FIG. 9, the brand system 110 includes a management engine 902, a brand registration engine 904, a brand loyalty engine 906, a brand reimbursement engine 908, a communication engine 910, and a brand system datastore 920.

The management engine 902 may function to manage (e.g., create, read, update, delete, or otherwise access) user profiles 930, modification objects 932, and/or transaction information 934 (e.g., local data 140, filtered data 321, target-formatted data 323, reports 326), any of which may be stored in the brand system datastore 920 and/or other datastore(s) associated with the brand system 110. The management engine 902 may perform any of these operations manually (e.g., by a user interacting with a GUI) and/or automatically (e.g., triggered by one or more of the engines 904-910). Like other engines described herein, some or all of the functionality of the management engine 902 may be included in and/or cooperate with one or more other engines (e.g., engines 904-910).

The brand registration engine 904 may function to register users. For example, the brand registration engine 904 may create, read, update, and/or delete user profiles 930. User profiles 930 may include some or all of the following information:
User Profile Identifier: identifies the user profile.
User Identifier: identifies the user (e.g., a phone number)
Contact Information: contact information for the user, such as mailing address, email address, phone number.
Loyalty Programs: Currently registered loyalty programs.
Loyalty History: rewards previously received.
Transaction History: Transaction history for transactions that include rewards, and/or transaction that do not include rewards.

In some embodiments, the brand registration engine 904 functions to register users with the brand system 110 and/or a central server system (e.g., central server system 108). For example, the brand registration engine 904 may function to register users for one or more loyalty programs. In some embodiments, a loyalty program may refer to a set of one or more modification objects. For example, a loyalty program may comprise rewards related to bottles of Coca-Cola, and the modification objects for that program may have varying attributes (e.g., different reward rules). In some embodiments, a modification object, as used herein, may define one or more rewards. Accordingly, a reward as used herein, may refer to a modification object, and/or vice versa.

In some embodiments, users must be registered in order to be eligible to receive rewards. For example, a user may provide their user identifier to a point of sale system and/or related system, and the central server system may provide the user identifier to the brand system 110, and the brand registration engine 904 may determine whether the user is registered. If the user is registered, the brand registration engine 904 may use their user profile 930 to determine whether the user is eligible for a reward. If the user is not registered, it may prompt and/or otherwise instruct the user to register with the brand system 110 and/or the central server system.

The brand loyalty engine 906 may function to obtain (e.g., pull), manage, provide (e.g., push), and/or generate modification objects 932. Modification objects 932 may refer to modification objects that are created and/or managed by the brand system 110. For example, the brand registration engine 318 may route modification objects 932 to point of sale systems (e.g., point of sale system 102) through a central location (e.g., central server system 108) and a client system (e.g., client system 106). The brand registration engine 318 may use brand interface 160 for communicating and/or cooperating with the central server system (e.g., via server interfaces 144).

In some embodiments, modification objects 932 may comprise rewards of a loyalty program. Rewards may include discounts (e.g., 50% discount, $5 discount), credits (e.g., buy 10 items and get 1 free), points (e.g., accrue 100 points, and get 1 item free), and/or other offers (e.g., two-for-one, buy two and get third 50% off). Loyalty programs may be brand-specific and/or retailer-specific.

In some embodiments, a modification object 932 may include some or all of the following information:
Reward Identifier: identifies the modification object and/or reward.
Item(s): items and/or item data (e.g., UPC codes) of items eligible for the reward.
Retailer(s): retailer where the reward may be redeemed (e.g., Jim's Store and John's Store).
Reward Rules: Specifies eligibility requirements, and/or the particular reward (e.g., 50% off).
Geographic Locations: particular geographic locations (e.g., states, cities, neighborhoods) associated with the modification object and/or reward.
Dates: particular dates (e.g., certain days, months, or times of day) associated with the modification object and/or reward (e.g., when the reward may be offered and/or redeemed).
Users: For example, specific users eligible for reward, or user-specific rewards.

The brand reimbursement engine 908 may function to provide and/or facilitate reimbursements associated with modification objects 932. For example, the brand reimbursement engine 908 may receive (e.g., from a central server system 108) a report of transaction information including reward information, and the brand reimbursement engine 908 may reimburse retailers. Transaction information may include transaction amounts indicating a reimbursement amount (e.g., $2), and that may be provided to the brand systems in real-time and/or periodically (e.g., monthly, along with other transaction information of other transactions). In another example, the brand reimbursement engine 908 receives and/or processes invoices received from a remote system (e.g., central server system 108). The brand reimbursement engine 908 may provide payment to the remote system that provided the invoice (e.g., the central server system 108).

The communication engine 910 may function to send requests, transmit and, receive communications, and/or otherwise provide communication with one or a plurality of the systems, engines, and/or datastores described herein. In some embodiments, the communication engine 910 functions to encrypt and decrypt communications. The communication engine 910 may function to send requests to and receive data from one or more systems through a network or a portion of a network. Depending upon implementation-specific considerations, the communication engine 910 may send requests and receive data through a connection, all or a portion of which may be a wireless connection. The communication engine 910 may request and receive messages, and/or other communications from associated systems and/or engines. Communications may be stored in the brand system datastore 920.

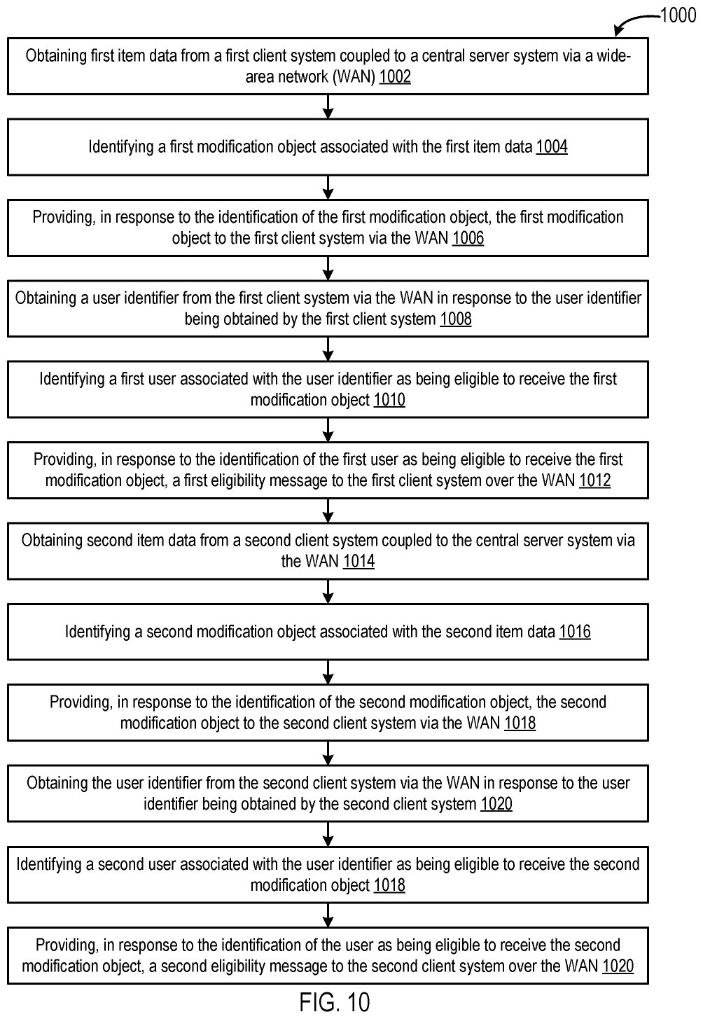

FIG. 10 depicts a flowchart of an example method 1000 of operation of a central server system for providing retailer-agnostic rewards, according to some embodiments.

In step 1002, a central server system (e.g., central server system 108) obtains first item data (e.g., first local data 120) from a first client system (e.g., client system 106-1) coupled to the central server system via a wide-area network (e.g., communications network 116) in response to the first item data being obtained by the first client system from a first point of sale system (e.g., point of sale system 102) via a first local-area network in response to the first item data being obtained by the first point of sale system at a first time. Accordingly, the central server system may obtain the first item data in real-time.

The first point of sale system may be associated with a first owner entity (e.g., John Doe and/or John's Store). The first time may be a timestamp (e.g., Jan. 1, 2018 at 6:49 AM) and/or may indicate when a corresponding first item is scanned and/or purchased. For example, the first item data may be a UPC code and/or other identifier of a bottle of Coca-Cola. In some embodiments, a central server loyalty engine (e.g., central server loyalty engine 318) receives the first item data from a communication engine (e.g., communication engine 314) that receives the first item data over the communications network.

In step 1004, the central server system identifies a first modification object (e.g., modification object 332 or modification object 932) associated with the first item data. The first modification object may define reward information. Reward information may comprise one or more attributes of a modification object (e.g., reward identifier, retailer identifier, reward rules, reward information). In some embodiments, the central server loyalty engine identifies the first modification object.

In some embodiments, the first modification object is associated with a first brand system (e.g., brand system 110-1). For example, the first modification object may define a Coca-Cola reward of a Coca-Cola loyalty program, and the first brand system may comprise a Coca-Cola system. In some embodiments, a loyalty program may refer to a set of one or more modification objects. For example, a loyalty program may comprise rewards related to two-liter bottles of Coca-Cola, and the modification objects for that program may have varying attributes (e.g., different reward rules). In some embodiments, a modification object, as used herein, may define one or more rewards. Accordingly, a reward as used herein, may refer to a modification object, and/or vice versa.

In some embodiments, the identifying the first modification object further comprises identifying the first modification object based on the user identifier and/or the first item data. For example, the central server loyalty engine may identify the first modification object based on the user identifier and the first item data. In another example, the central server loyalty engine may identify the first modification based on the first item data, without the user identifier. This may, for example, allow the central server system to pre-load rewards prior to determining whether the user is eligible for the rewards. For example, the central server system may facilitate provisioning of modification objects to the client system and/or point of sale system prior to receiving a user identifier and/or determining whether the user identifier is eligible to receive the reward. This may, for example, facilitate providing rewards in real-time.

In some embodiments, the identifying the first modification object further comprises identifying the first modification object from a first set of modification objects managed by the central server system. The central server loyalty engine may implement one or more server interfaces (e.g., server interfaces 144) that cooperate with one or more brand interfaces (e.g., brand interfaces 160). The central server loyalty engine may point to, and/or cooperate with, the brand system using the server interfaces and the brand interfaces. This may, for example, allow the brand system to manage rewards, and utilize the central server system for provisioning rewards. For example, the central server system may route, and/or facilitate routing, rewards to client systems and/or point of sale systems.

In step 1006, the central server system provides, in response to the identification of the first modification object, the first modification object to the first client system via the WAN. The first client system may be configured to provide (e.g., in response to receiving the first modification object) the first modification object to the first point of sale system via the first LAN. In some embodiments, the central server loyalty engine and/or communication engine provide the first modification object to the first client system.

In step 1008, the central server system obtains a user identifier from the first client system via the WAN in response to the user identifier being obtained by the first client system from the first point of sale system via the first LAN in response to the user identifier being obtained by the first point of sale system at a second time. Accordingly, the central server system may obtain the user identifier in real-time. In some embodiments, the central server loyalty engine and/or the communication engine obtain the first user identifier.

In some embodiments, the second time may be a timestamp (e.g., Jan. 1, 2018 at 6:50 AM) and/or may indicate when the user identifier is provided to, and/or obtained by, the point of sale system and/or associated system.

In step 1010, the central server system identifies a first user associated with the user identifier as being eligible to receive the first modification object. The central server system may compare a user profile (e.g., user profile 330) associated with the user identifier with attributes of the first modification object. For example, the central server system may determine whether the user has accrued enough points to be eligible, whether the user has registered for the loyalty program, and/or the like. In some embodiments, the central server loyalty engine identifies the user.

In step 1012, the central server system provides, in response to the identification of the first user as being eligible to receive the first modification object, a first eligibility message to the first client system over the WAN. The first eligibility message may indicate eligibility of the first user to receive the first modification object. The first client system may be configured to provide the first eligibility message to the first point of sale system. The first point of sale may be configured to generate first modified transaction data based on the first modification object. Accordingly, the central server system may be able to provide information (e.g., eligibility messages, modification objects) in real-time, and/or the point of sale systems may be able to process eligibility messages and/or apply modification objects in real-time to generate modification transaction data in real-time. As used herein, real-time may include near real-time. In some embodiments, the central server loyalty engine and/or communication engine provides the first eligibility message.

In some embodiments, the first modified transaction data may include, and/or otherwise indicate, the first item data, an original price (e.g., $2) associated with the first item data, a discount amount (e.g., $1), a reward rule (e.g., %50 off), a transaction amount (e.g., $1), and/or a reimbursement amount (e.g., $1). The first modified transaction data may be generated immediately after the later of the first time and the second time. For example, it may be generated after the user identifier is obtained if the user identifier is obtained after the first item data is obtained.

In step 1014, the central server system obtains second item data (e.g., second local data 122) from a second client system (e.g., client system 106-N) coupled to the central server system via the WAN in response to the second item data being obtained by the second client system from a second point of sale system (e.g., second point of sale system 104) via a second LAN in response to the second item data being obtained by the second point of sale system at a third time. Accordingly, the central server system may obtain the second item data in real-time.

The second point of sale system may be associated with a second owner entity (e.g., Joe Smith and/or Joe's Store). The third time may be a timestamp (e.g., Jan. 4, 2018 at 7:28 PM) and/or may indicate when a corresponding second item is scanned and/or purchased. For example, the second item data may be a UPC code and/or other identifier of a bottle of Pepsi. In some embodiments, a central server loyalty engine (e.g., central server loyalty engine 318) receives the second item data from a communication engine (e.g., communication engine 314) that receives the second item data over the communications network.

In step 1016, the central server system identifies a second modification object (e.g., a modification object 332 or modification object 932) associated with the second item data. The second modification object may define reward information. The reward information may comprise one or more attributes of a modification object (e.g., reward identifier, retailer identifier, reward rules, reward information). In some embodiments, the central server loyalty engine identifies the second modification object.

In some embodiments, the identifying the second modification object further comprises identifying the second modification object based on the user identifier and the second item data. For example, the central server loyalty engine may identify the second modification object based on the user identifier and the second item data. In another example, the central server loyalty engine may identify the second modification object based on the second item data, without the user identifier. This may, for example, allow the central server system to pre-load rewards prior to determining whether the user is eligible for the rewards. This may, for example, facilitate providing rewards in real-time.

In some embodiments, the second modification object is associated with a second brand system (e.g., brand system 110-N). For example, the second modification object may define a Pepsi reward of a Pepsi loyalty program, and the second brand system may comprise a Pepsi system.

In some embodiments, the identifying the second modification object further comprises obtaining the second modification object from a second set of modification objects managed by the second brand system. In some embodiments, the central server system obtains the second modification object using one or more first application programming interfaces (e.g., server interfaces 144) of the central server system. The one or more first APIs may be configured to cooperate with one or more second APIs (e.g., brand interfaces 160-N) of the second brand system.

In step 1018, the central server system provides, in response to the identification of the second modification object, the second modification object to the second client system via the WAN. The second client system may be configured to provide the second modification object to the second point of sale system via the second LAN (e.g., in response to the second client system receiving the second modification object). In some embodiments, the central server loyalty engine and/or communication engine provides the second modification object.

In step 1020, the central server system obtains the user identifier from the second client system via the WAN in response to the user identifier being obtained by the second client system from the second point of sale system via the second LAN in response to the user identifier being obtained by the second point of sale system at a fourth time. Accordingly, the central server system may obtain the user identifier in real-time. In some embodiments, the central server loyalty engine and/or the communication engine obtain the second user identifier.

The fourth time may be a timestamp (e.g., Jan. 4, 2018 at 7:29 PM) and/or may indicate when the user identifier is provided to, and/or obtained by, the point of sale system and/or related system.

In step 1022, the central server system identifies the user associated with the user identifier as being eligible to receive the second modification object. The central server system may compare a user profile (e.g., user profile 330) associated with the user identifier with attributes of the second modification object. For example, the central server system may determine whether the user has accrued enough points to be eligible, whether the user has registered for the loyalty program, and/or the like. In some embodiments, the central server loyalty engine identifies the user.

In step 1024, the central server system provides, in response to the identification of the user as being eligible to receive the second modification object, a second eligibility message to the second client system over the WAN. The second eligibility message may indicate eligibility of the user to receive the second modification object. The second client system may be configured to the provide the second eligibility message to the second point of sale system. The second point of sale may be configured to generate second modified transaction data based on the second modification object. The second modified transaction data may include, and/or otherwise indicate, the second item data, an original price (e.g., $4) associated with the second item data, a discount amount (e.g., $1), a reward rule (e.g., %25 off), a transaction amount (e.g., $3), and/or a reimbursement amount (e.g., $1). The second modified transaction data may be generated immediately after the later of the third time and the fourth time. For example, it may be generated after the user identifier is obtained if the user identifier is obtained after the second item data is obtained.

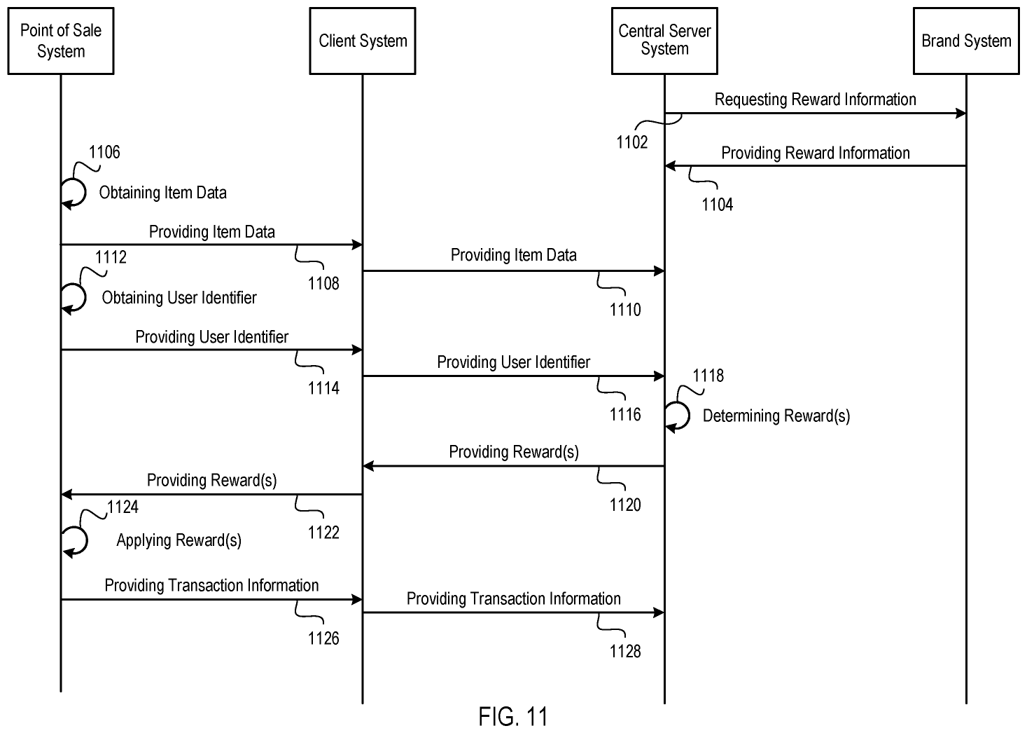

FIG. 11 depicts a flowchart of an example method 1100 for providing retailer-agnostic rewards managed by a central server system, according to some embodiments.

In step 1102, a central server system (e.g., central server system 108) requests reward information (e.g., modification objects 932) from a brand system (e.g., brand system 110). In step 1104, the brand system provides the reward information to the central server system. The central server system may store the reward information as modification objects (e.g., modification objects 332).

In step 1106, a point of sale system (e.g., point of sale system 102) obtains item data. In step 1108, the point of sale system provides the item data to a client system (e.g., client system 106). In step 1110, the client system provides the item data to the central server system.

In step 1112, the point of sale system obtains a user identifier (e.g., phone number). For example, a user may provide their user identifier to a point of sale system via a keypad of the point of sale systems and/or a related system including a keypad and/or other input device. In some embodiments, 1114, the point of sale system provides the user identifier to the client system. In some embodiments, step 1116, the client system provides the user identifier to the central server system.

In step 1118, the central server system determines one or more rewards. For example, the central server system may identify and/or determine one or more modification objects managed by the central server system based on the user identifier and/or the item data.

In step 1120, the central server system provides the one or more rewards to the client system. In step 1122, the client system provides the one or more rewards to the point of sale system. In step 1124, the point of sale system applies the one or more rewards.

In step 1126, the point of sale system provides the transaction information (or, modified transaction information) to the client system. In step 1128, the client system provides the transaction information the central server system. The central server system may store the transaction information as local data (e.g., local data 140) and/or attribute(s) of a user profile (e.g., user profile 330).

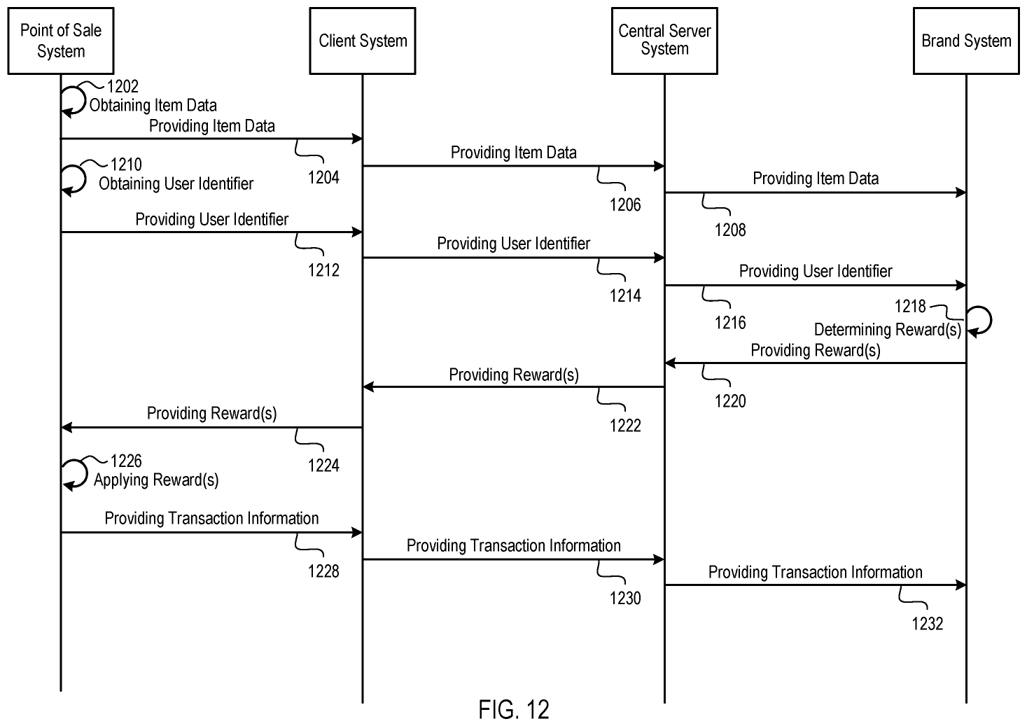

FIG. 12 depicts a flowchart of an example method 1200 for providing retailer agnostic rewards managed by a brand system, according to some embodiments.

In step 1202, a point of sale system (e.g., point of sale system 102) obtains item data. In step 1204, the point of sale system provides the item data to a client system (e.g., client system 106). In step 1206, the client system provides the item data to a central server system (e.g., central server system 108). In step 1208, the central server system provides the item data to a brand system (e.g., brand system 110).

In step 1210, the point of sale system obtains a user identifier (e.g., phone number). In step 1212, the point of sale system provides the user identifier to the client system. In step 1214, the client system provides the user identifier to the central server system. In step 1216, the central server system provides the user identifier to the brand system. In some embodiments, the central server system may anonymize and/or otherwise modify the secure user identifier. Accordingly, it will be appreciated that, in some embodiments, reference to a secure user identifier (e.g., the secure user identifier that is provided to the brand system) may comprise an anonymized and/or otherwise modified variant of the secure user identifier.

In step 1218, the brand system determines one or more rewards (e.g., modification objects 932) based on user identifier and/or the item data. In step 1220, the brand system provides the one or more rewards to the central server system. In step 1222, the central server system provides the one or more rewards to the client system. In step 1224, the client system provides the one or more rewards to the point of sale system.

In step 1226, the point of sale system applies the one or more rewards. In step 1228, the point of sale system generates and/or provides transaction information (or modified transaction information) to the client system. As used herein, transaction information and/or modified transaction information may comprises local data (e.g., local data 120 and/or local data 140). In step 1230, the client system provides the transaction information to the central server system. In step 1232, the client system provides the transaction information to the brand system. The brand system may store the transaction information.

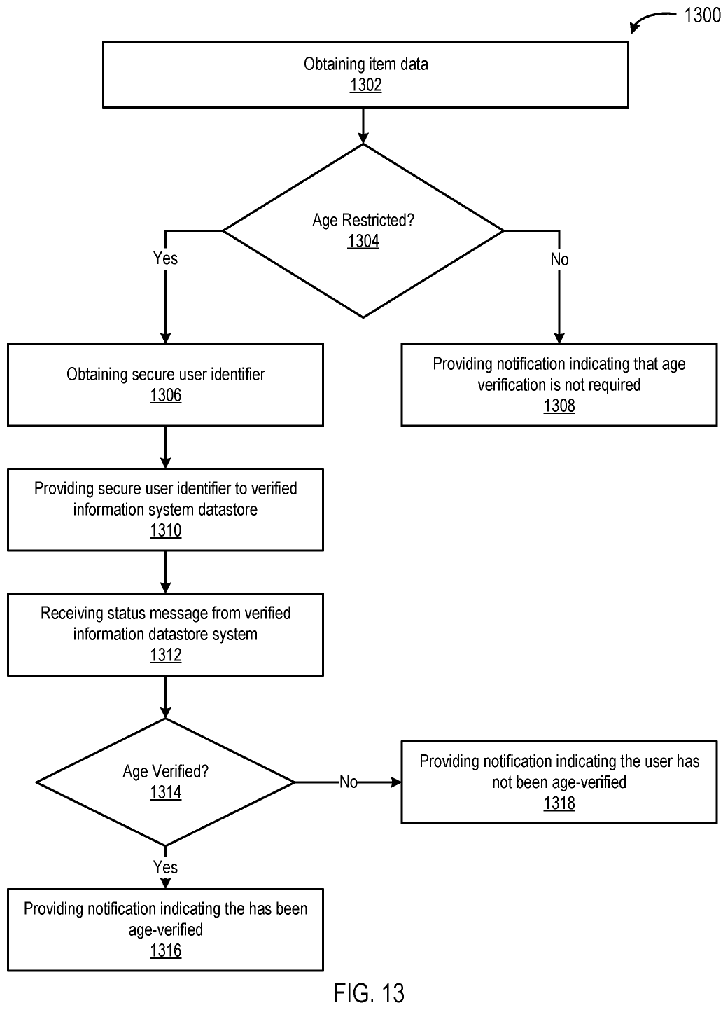

FIG. 13 depicts a flowchart of an example method 1300 of operation of a central server system for providing age verification of age-restricted items.

In step 1302, a central server system (e.g., central server system 108) obtains item data. For example, a point of sale system and/or related system may scan the item data, and provide the item data to a client system (e.g., client system 106) over a LAN, and the client system may then provide the item data to the central server system over a WAN (e.g., communications network 116). These operations may be performed in real-time.

In step 1304, the central server system determines whether the item data is age-restricted. For example, the central server system may maintain a datastore of age-restricted items (e.g., tobacco, alcohol) and their properties, such as required age (e.g., 18, 21). In some embodiments, an age verification engine (e.g., age verification engine 322) determines whether the item is age-restricted.

In some embodiments, the central server system may cooperate with one or more remote systems to determine whether the item data is age-restricted. The central server system may use server interfaces (e.g., server interfaces) 144 to cooperate with a brand system (e.g., brand system 110) using brand interfaces (e.g., brand interfaces 160) to determine whether the item data is age-restricted. For example, the brand system may maintain a datastore of age-restricted items (e.g., tobacco, alcohol) of that brand and their properties, such as required age (e.g., 18, 21), and the central server system may cooperate with the brand system to obtain that information. The central server system may cooperate with one or more relevant brand systems.

In some embodiments, if the item data is age-restricted, the central server system may provide an age-restriction notification indicating the item-data is age restricted. For example, the central server system may provide the notification to the client system over the WAN, and the client system may provide the notification to the point of sale system over the LAN. The notification may prevent the point of sale system of processing a transaction including the item data without obtaining a secure user identifier. For example, the notification may cause the transaction to be in a locked state until (or, unless) the point of sale system receives a message indicate that authenticated secure user identifier has been obtained for that transaction.

In some embodiments, in addition to, or instead of locking a transaction, the transaction may be voided, and/or the age-restricted item may be canceled (e.g., removed from the transaction). For example, if a clerk scans a UPC code of a box of cigarettes and the secure user identifier is not authorized (e.g., the age associated with the secure user identifier is not over the required age limit, or the secure user identifier is fake), some or all of the systems herein may remove that item from the transaction.

In some embodiments, if the item data is not age-restricted, the central server system may provide an age-restriction notification indicating the item-data is not age restricted. For example, the central server system may provide the notification to the client system over the WAN, and the client system may provide the notification to the point of sale system over the LAN. The notification may allow the point of sale system to process a transaction including the item data without obtaining a secure user identifier. For example, the notification may cause the transaction to be in an unlocked state.

In some embodiments, the transaction may be switched between unlocked and locked states any number of times. For example, a transaction may include the first item data and one or more second item data. If the first item data is not age restricted, the transaction may be in an unlocked state, but if at least one of the one or more second item data is age-restricted, the transaction may be switched to a locked state.

In step 1306, the central server system obtains a secure user identifier (e.g., a driver's license number and/or copy thereof) in response to determining the item data is age restricted. For example, the point of sale system may obtain a photograph and/or scanned image of a driver's license, and/or portion thereof (e.g., barcode, driver's license number), of the user. The point of sale system may provide the secure user identifier to the client system over the LAN, and the client system may provide the secure user identifier to the central server system over the WAN. These operations may be performed in real-time. In some embodiments, the age verification engine obtains the secure user identifier.

In some embodiments, the central server system may store the secure user identifier. For example, the central server system may store the secure user identifier in an associated user profile (e.g., user profile 330). This may, for example, allow future transactions to only require a user identifier (e.g., phone number) to be provided to the point of sale system, and the central server system may then lookup the secure user identifier based on the user identifier.

In step 1308, the central server system provides a notification indicating that the item data is not age-restricted, and/or that age verification is not required, in response to determining the item data is not age restricted. For example, the central server system may provide the notification to the client system over the WAN, and the client system may provide the notification to the point of sale system over the LAN. In some embodiments, the age verification engine provides the notification.

In step 1310, the central server system provides the secure user identifier to a verified information datastore system (e.g., verified information datastore system 180) over the WAN and/or other network. In some embodiments, the verified information datastore system compares the secure user identifier with verified information (e.g., verified information 182) to determine whether the secure user identifier is authentic. The verified information datastore system may generate and/or provide a status message indicating a result of the determination.

In step 1312, the central server system receives a status message from the verified information datastore system indicating whether the secure user identifier is authentic. In some embodiments, the age verification engine receives the status message.

In step 1314, the central server system determines whether the user is age-verified based on the status message. For example, if the status message indicates that the secure user identifier is authentic, and the secure user identifier indicates an eligible age relative to the age-restriction of the item data, the central server system may determine the user is age-verified, and provide a corresponding notification (step 1316). The corresponding notification may be referred to as a valid secure user identifier notification. For example, the central server system may provide the notification to the client system over the WAN, and the client system may provide the notification to the point of sale system over the LAN. The notification may cause an associated transaction to be in an unlocked state.

In some embodiments, if the secure user identifier is authentic, the central server system may update the associated user profile to indicate that the secure user identifier is authentic. This may, for example, allow the central server system to determine that the secure user identifier is authentic for a period of time (e.g., until the expiration date of the driver's license) without having to access to the verified information datastore system for each subsequent transaction using that user identifier. In some embodiments, the age verification engine determines whether the user is age-verified and/or whether the secure user identifier is authentic.

In step 1318, if the central server system determines the user is not age-verified, the central server system provides a corresponding notification (e.g., an invalid secure user identifier notification)to the client system over the WAN. The client system may then provide the corresponding notification to the point of sale system over the LAN. The corresponding notification may be capable of preventing the transaction including the item data from being processed (e.g., by the point of sale system). The corresponding notification may cause an associated transaction to be in a locked state. In some embodiments, the age verification engine provides the notification.

In some embodiments, age-verification may be performed through the brand system. For example, the point of sale may receive the secure user identifier, pass it to the client system, which will then pass it to the central server system. The system central server system may pass the secure user identifier to the brand system, and the brand system may pass the secure user identifier to the verified information datastore system. The brand system may then receive a verification result based on the secure user identifier (e.g., verified or not verified) from the verified information datastore system, and pass the result to the central server system. The central server system may then indicate whether the associated transaction should be authorized or not authorized based on the result.

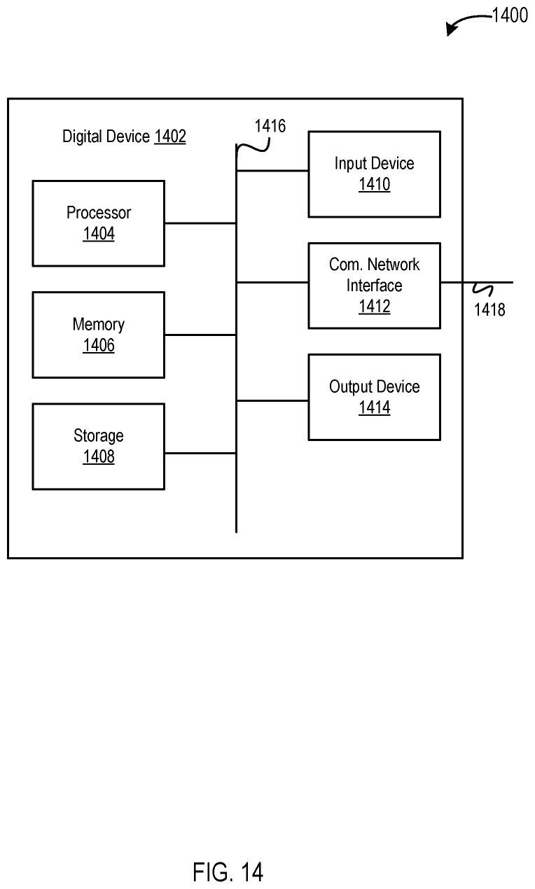

FIG. 14 depicts a diagram of an example computing device 1402. Any of the systems, engines, datastores, and/or networks described herein may comprise an instance of one or more computing devices 1402. In some embodiments, functionality of the computing device 1402 may perform some or all of the functionality described herein. The computing device 1402 comprises a processor 1404, memory 1406, storage 1408, an input device 1410, a communication network interface 1412, and an output device 1414 communicatively coupled to a communication channel 1416. The processor 1404 is configured to execute executable instructions (e.g., programs). In some embodiments, the processor 1404 comprises circuitry or any processor capable of processing the executable instructions.

The memory 1406 stores data. Some examples of memory 1406 include storage devices, such as RAM, ROM, RAM cache, virtual memory, etc. In various embodiments, working data is stored within the memory 1406. The data within the memory 1406 may be cleared or ultimately transferred to the storage 1408.

The storage 1408 includes any storage configured to retrieve and store data. Some examples of the storage 1408 include flash drives, hard drives, optical drives, cloud storage, and/or magnetic tape. Each of the memory system 1406 and the storage system 1408 comprises a computer-readable medium, which stores instructions or programs executable by processor 1404.

The input device 1410 is any device that inputs data (e.g., mouse and keyboard). The output device 1414 outputs data (e.g., a speaker or display). It will be appreciated that the storage 1408, input device 1410, and output device 1414 may be optional. For example, the routers/switches may comprise the processor 1404 and memory 1406 as well as a device to receive and output data (e.g., the communication network interface 1412 and/or the output device 1414).

The communication network interface 1412 may be coupled to a network (e.g., network 108) via the link 1418. The communication network interface 1412 may support communication over an Ethernet connection, a serial connection (e.g., USB), a parallel connection, and/or an ATA connection. The communication network interface 1412 may also support wireless communication (e.g., 802.11 a/b/g/n, WiMax, LTE, WiFi). It will be apparent that the communication network interface 1412 may support many wired and wireless standards.

It will be appreciated that the hardware elements of the computing device 1402 are not limited to those depicted in FIG. 14. A computing device 1402 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1404 and/or a co-processor located on a GPU (e.g., NVIDIA).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially hardware-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A central server system comprising:
one or more processors; and
memory storing instructions that, when executed by the one or more processors, cause the central server system to perform:
obtaining first item data from a first client system coupled to a central server system via a wide-area network (WAN) in response to the first item data being obtained by the first client system from a first point of sale system via a first local-area network (LAN) in response to the first item data being obtained by the first point of sale system at a first time, the first point of sale system being associated with a first owner entity;
determining whether the first item data is age-restricted;
providing, in response to determining the first item data is age-restricted, an age-restriction notification to the first client system via the WAN, the first client system being configured to provide the age-restriction notification to the first point of sale system via the first LAN, the age-restriction notification being capable of preventing the first point of sale system from completing a transaction including the first item data unless a subsequent message indicates the transaction is eligible for completion.

2. The central server system of claim 1, wherein the first item data comprises a universal product code (UPC).

3. The central server system of claim 1, wherein the instructions further cause the system to perform:
obtaining, in response to determining the first item data is age-restricted, a secure user identifier from the first client system via the WAN in response to the user identifier being obtained by the first client system from the first point of sale system via the first LAN in response to the user identifier being obtained by the first point of sale system at a second time;
providing, in response to obtaining the secure user identifier, the secure user identifier to a remote third-party system over the WAN, the remote third-party system capable of determining an authenticity of the secure user identifier;
receiving, over the WAN, a status message from the remote third-party system, the status message indicating whether secure user identifier is authentic or not authentic.

4. The central server system of claim 3, wherein the secure user identifier comprises at least a portion of identification information of a driver's license.

5. The central server system of claim 3, wherein the remote third-party system comprises a Department of Motor Vehicles (DMV) system.

6. The central server system of claim 3, wherein if the status message indicates that the secure user identifier is not authentic, the instructions further cause the system to perform:
providing an invalid secure user identifier notification to the first client system via the WAN, the first client system being configured to provide the invalid secure user identifier notification to the first point of sale system via the first LAN, the invalid secure user identifier notification being capable of preventing the first point of sale system from completing the transaction including the first item data without obtaining the subsequent message indicating the transaction is eligible for completion.

7. The central server system of claim 3, wherein if the status message indicates that the secure user identifier is authentic, the instructions further cause the system to perform:
providing a valid secure user identifier notification to the first client system via the WAN, the first client system being configured to provide the valid secure user identifier notification to the first point of sale system via the first LAN, the valid secure user identifier notification being capable of causing the first point of sale system to be allowed to complete the transaction including the first item data.

8. A method being implemented by a computing system including one or more physical processors and storage media storing machine-readable instructions, the method comprising:
obtaining first item data from a first client system coupled to a central server system via a wide-area network (WAN) in response to the first item data being obtained by the first client system from a first point of sale system via a first local-area network (LAN) in response to the first item data being obtained by the first point of sale system at a first time, the first point of sale system being associated with a first owner entity;
determining whether the first item data is age-restricted;
providing, in response to determining the first item data is age-restricted, an age-restriction notification to the first client system via the WAN, the first client system being configured to provide the age-restriction notification to the first point of sale system via the first LAN, the age-restriction notification being capable of preventing the first point of sale system from completing a transaction including the first item data unless a subsequent message indicates the transaction is eligible for completion.

9. The method of claim 8, wherein the first item data comprises a universal product code (UPC).

10. The method of claim 8, wherein the method further comprises:
obtaining, in response to determining the first item data is age-restricted, a secure user identifier from the first client system via the WAN in response to the user identifier being obtained by the first client system from the first point of sale system via the first LAN in response to the user identifier being obtained by the first point of sale system at a second time;
providing, in response to obtaining the secure user identifier, the secure user identifier to a remote third-party system over the WAN, the remote third-party system capable of determining an authenticity of the secure user identifier;
receiving, over the WAN, a status message from the remote third-party system, the status message indicating whether secure user identifier is authentic or not authentic.

11. The method of claim 10, wherein the secure user identifier comprises at least a portion of identification information of a driver's license.

12. The method of claim 10, wherein the remote third-party system comprises a Department of Motor Vehicles (DMV) system.

13. The method of claim 10, wherein if the status message indicates that the secure user identifier is not authentic, the method further comprises:
providing an invalid secure user identifier notification to the first client system via the WAN, the first client system being configured to provide the invalid secure user identifier notification to the first point of sale system via the first LAN, the invalid secure user identifier notification being capable of preventing the first point of sale system from completing the transaction including the first item data without obtaining the subsequent message indicating the transaction is eligible for completion.

14. The method of claim 10, wherein if the status message indicates that the secure user identifier is authentic, the method further comprises:
providing a valid secure user identifier notification to the first client system via the WAN, the first client system being configured to provide the valid secure user identifier notification to the first point of sale system via the first LAN, the valid secure user identifier notification being capable of causing the first point of sale system to be allowed to complete the transaction including the first item data.

15. A non-transitory computer readable medium comprising instructions that, when executed, cause one or more processors to perform:
obtaining first item data from a first client system coupled to a central server system via a wide-area network (WAN) in response to the first item data being obtained by the first client system from a first point of sale system via a first local-area network (LAN) in response to the first item data being obtained by the first point of sale system at a first time, the first point of sale system being associated with a first owner entity;
determining whether the first item data is age-restricted;
providing, in response to determining the first item data is age-restricted, an age-restriction notification to the first client system via the WAN, the first client system being configured to provide the age-restriction notification to the first point of sale system via the first LAN, the age-restriction notification being capable of preventing the first point of sale system from completing a transaction including the first item data unless a subsequent message indicates the transaction is eligible for completion.

16. The non-transitory computer readable medium of claim 15, wherein the wherein the first item data comprises a universal product code (UPC).

17. The non-transitory computer readable medium of claim 15, wherein the instructions further cause the system to perform:
obtaining, in response to determining the first item data is age-restricted, a secure user identifier from the first client system via the WAN in response to the user identifier being obtained by the first client system from the first point of sale system via the first LAN in response to the user identifier being obtained by the first point of sale system at a second time;
providing, in response to obtaining the secure user identifier, the secure user identifier to a remote third-party system over the WAN, the remote third-party system capable of determining an authenticity of the secure user identifier;
receiving, over the WAN, a status message from the remote third-party system, the status message indicating whether secure user identifier is authentic or not authentic.

18. The non-transitory computer readable medium of claim 17, wherein the secure user identifier comprises at least a portion of identification information of a driver's license.

19. The non-transitory computer readable medium of claim 17, wherein the remote third-party system comprises a Department of Motor Vehicles (DMV) system.

20. The non-transitory computer readable medium of claim 17, wherein if the status message indicates that the secure user identifier is not authentic, the instructions further cause the system to perform:
providing an invalid secure user identifier notification to the first client system via the WAN, the first client system being configured to provide the invalid secure user identifier notification to the first point of sale system via the first LAN, the invalid secure user identifier notification being capable of preventing the first point of sale system from completing the transaction including the first item data without obtaining the subsequent message indicating the transaction is eligible for completion.
